(19) United States
(12) Patent Application Publication
(10) Pub. No.: US 2025/0232655 A1
(43) Pub. Date: Jul. 17, 2025

(54) SYSTEM AND METHOD FOR MONITORING PRODUCT

(71) Applicant: WESTROCK SHARED SERVICES, LLC, ATLANTA, GA (US)

(72) Inventors: KENNETH L. GLINERT, CHAPPAQUA, NY (US); JOHN P. DWYER, OAK PARK HEIGHTS, MN (US); MICHAEL MCGRAY, Naples, FL (US)

(21) Appl. No.: 18/409,944

(22) Filed: Jan. 11, 2024

(51) Int. Cl. G08B 13/24; G06Q 10/087

(52) U.S. Cl. CPC G08B 13/2462; G06Q 10/087

(57) ABSTRACT

One or more techniques and/or systems are disclosed for monitoring a product having a tag associated therewith. The technique includes receiving tag data associated with the tag indicating the product is located outside a defined coverage range. The technique further includes determining, based on the received tag data, a period of time the product has been located outside the defined coverage range. In response to the determined period of time exceeding a defined time limit, accessing a database storing data identifying products that have been purchased. The technique also includes determining, based on the data identifying products that have been purchased, whether the product has been purchased.

### FIELD

The present disclosure relates to a system and method for monitoring a product for theft or fraud. More specifically, the present disclosure relates to a system and method for monitoring a location of a product by monitoring a location of a tag associated with the product, such that the tagged product is monitored.

### BACKGROUND

Monitoring systems, for example, tracking systems such as radio-frequency identification (RFID) systems, can be used for a number of applications. For example, monitoring systems can be used for managing inventory, electronic access control, security systems, automatic identification of cars on toll roads, and electronic article surveillance (EAS). In these systems, tracking devices or other sensors applied to articles or items may be used to track or monitor the articles or items. The tracking devices, such as sensors, are being used to provide product traceability, provenance, brand authentication, and diversion.

However, monitoring systems, such as ones using tracking devices affixed to product or packaging for location monitoring, are often costly to implement and limited to the tracking of product at very early stages of the shipping process. And, in many systems, a monitoring devices tracks all of the product in a same area nearly instantaneously, making it more difficult to perform individualized tracking.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

One or more techniques and systems are described herein for monitoring a product using a tag that is coupled to and linked with the product. In one implementation, there is provided a control system operable for monitoring a product having a tag associated therewith. The control system comprises a control system processor. The control system further comprises a non-transient memory device operatively coupled with the control system processor, the non-transient memory device storing: tag data associated with the tag indicating the product is located outside a defined coverage range; and a defined time limit the product is permitted to be located outside the defined coverage range. The control system further comprises control logic stored in the non-transient memory device and executable by the control system processor to: determine, based on the tag data, a period of time the product has been located outside the defined coverage range. The control logic stored in the non-transient memory device is further executable by the control system processor to: in response to the determined period of time exceeding a defined time limit, access a database storing data identifying products that have been purchased; and determine, based on the data identifying products that have been purchased, whether the product has been purchased.

In another implementation, there is provided a computer-implemented method for monitoring a product having a tag associated therewith. The method comprises performing product check in when the tag associated therewith moves inside a defined coverage range. The method further comprises performing product check out when the tag associated therewith moves outside the defined coverage range. Additionally, the method comprises determining, based on tag data associated with the tag indicating the product is located outside the defined coverage range, a period of time the product has been located outside the defined coverage range. Moreover, the method comprises that in response to the determined period of time exceeding a defined time limit, accessing a database storing data identifying products that have been purchased. The method also comprises determining, based on the data identifying products that have been purchased, whether the product has been purchased.

In still another implementation, there is provided a computer-implemented method for monitoring a product having a tag associated therewith. The method comprises receiving tag data associated with the tag indicating the product is located outside a defined coverage range. The method further comprises determining, based on the received tag data, a period of time the product has been located outside the defined coverage range. The method additionally comprises that in response to the determined period of time exceeding a defined time limit, accessing a database storing data identifying products that have been purchased. The method also comprises determining, based on the data identifying products that have been purchased, whether the product has been purchased.

To the accomplishment of the foregoing and related ends, the following description and annexed drawings set forth certain illustrative aspects and implementations. These are indicative of but a few of the various ways in which one or more aspects may be employed. Other aspects, advantages and novel features of the disclosure will become apparent from the following detailed description when considered in conjunction with the annexed drawings.

### BRIEF DESCRIPTION OF THE DRAWINGS

What is disclosed herein may take physical form in certain parts and arrangement of parts, and will be described in detail in this specification and illustrated in the accompanying drawings which form a part hereof and wherein:

FIG. 1 is a block diagram illustrating one example implementation of a system for monitoring product in accordance with this disclosure.

FIG. 2 is a block diagram illustrating one example implementation of a portion of the system of FIG. 1 for monitoring product according to this disclosure.

FIG. 3 illustrates a tag configuration according to one implementation.

FIG. 4 illustrates a tag configuration according to another implementation.

FIG. 5 illustrates one example implementation of a system for detecting and reporting theft of product according to this disclosure.

FIG. 6 is a schematic diagram illustrating one example implementation of a system for monitoring product according to this disclosure.

FIG. 7 is a schematic diagram illustrating another example implementation of a system for monitoring product according to this disclosure.

FIG. 8 is a flow diagram illustrating an example implementation of a method for monitoring product in accordance with this disclosure.

FIG. 9 is a flow diagram illustrating another example implementation of a method for monitoring product in accordance with this disclosure.

FIG. 10 is a block diagram of an example computing environment suitable for implementing various examples.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

One or more examples described herein provide a system and method for monitoring a product, such as a stored value product (e.g., a stored value card), using a tag that is coupled to and linked with the product. Since the location of the tag is indicative of the location of the product associated therewith, the location of the product can be monitored via the tag associated with the product. The removal of the product from a defined coverage range where the product is initially displayed (e.g., located) for retail for a period of time exceeding a defined time limit, without the product being purchased (e.g., at a point of sale device of the retailer) within the defined time limit, indicates the product may be subject to theft or fraud in various examples. In some examples, removal of the product from a defined coverage range where the product is initially displayed (e.g., located) for retail for a period of time exceeding a defined time limit, without the product being purchased or reentering the defined coverage range within the defined time limit, indicates the product may be subject to theft or fraud.

In one or more of these implementations, the system and/or method is configured to detect when the stored value card (e.g., a gift card or prepaid credit card) is transported outside the defined coverage range of a monitoring device (e.g., outside the perimeter delineating the outer periphery of the defined coverage range) by monitoring the location of the tag that is coupled to and linked with stored value card. In these implementations, the system and/or method can be further configured to detect, using the tag associated with the stored value card, when the stored value card is located outside the defined coverage range for a period of time exceeding a defined time limit without activation of the stored value card via purchase of the stored value card. In some implementations, the stored value card can be purchased at a point of sale device of the retailer (e.g., a cash register). In some implementations, the stored value card located outside the defined coverage range for the period of time exceeding the defined time limit, without activation of the stored value card via purchase of the stored value card or reentry of the stored value card into the defined coverage range prior to expiration of the defined time limit, indicates the stored value card is the subject of theft or fraud. In some examples, the system and/or method is configured to block activation (“halt” activation) of the stored value card determined to be the subject of theft or fraud.

Some implementations provide a system and method for creating a home base (also referred to herein as a home location) for displaying product for retail to mitigate or eliminate fraud/theft. As described in more detail herein, the system can establish a unique electronic identity associated with each product or each carrier containing the product, and can electronically tether or link the product to a specific location, for example the in-store location where the product is displayed for retail, thereby allowing the specific location to serve as the home location (home base). The home location can be located inside the defined coverage range (e.g., inside the defined coverage range). In one or more implementations, the system can electronically tether or link the product to a display structure containing the product for sale that is disposed within the defined coverage range. In particular, the system can electronically tether or link the product to the specific location of the display structure that is disposed inside the defined coverage range resulting in the display structure serving as the home base. This enables the system to identify which products are stocked to the specific location (e.g., the home location or home base) and which products have been removed, either for purchase or as part of a theft or fraud scheme, using the unique electronic identity. The retailer can set a defined time limit for the product to be absent from the home base (or home location), such as two (2) hours. If the product is not purchased from the retailer or the product does not reenter the defined coverage range within the defined time limit, the product can be assumed stolen. In implementations where the product is a stored value card, the stored value card can then be blocked from activation.

In some implementations, the system and/or method is configured to recognize the difference between the re-stocking of product, such as to replenish and/or replace product at the home location (e.g., a display structure functioning as the home base), and the theft or defrauding of product, such as when product is removed from its home location (e.g., a display structure functioning as the home base) and transported outside the defined coverage range. That is, some implementations provide a system and/or method that can discern the difference between, and thus distinguish between a re-stocking event where product is added and/or removed from the home base (e.g., display structure) located inside the defined coverage range, and a defrauding/theft event where product is removed from its home base (e.g., display structure) and subsequently transported outside the defined coverage range. In one or more implementations, an asset tag (e.g., a passive, semi-passive, or active tag) may be assigned to a product replenishment device used to re-stock (e.g., replenish or replace) the products at a home base (e.g., a display structure functioning as the home base) located inside the defined coverage range. In some examples, the product replenishment device is a cart and the asset tag is coupled to the cart. In some implementations, the system may be configured to detect the presence of the product replenishment device (e.g., cart) via the asset tag attached thereto when the product replenishment device is located within the defined coverage range, for example, when the product replenishment device is moved inside the defined coverage range (e.g., inside the perimeter).

In some of these implementations, the system can be configured to enter a re-stocking mode (also referred to as a replenishment state) permitting store personnel to remove, from the home base, product having a tag associated therewith and subsequently transport the product outside the defined coverage range (e.g., outside the perimeter) without triggering a signal notifying (e.g., alerting or warning) of potential fraud or theft of product. In one or more implementations, the re-stocking mode (or replenishment state) is a predefined mode/state that may be a factory preset or a user-defined setting. For the purpose of illustration and not limitation, the system may enter a re-stocking mode (a replenishment state) permitting store personnel to remove, from the home base (e.g., display structure), product having a tag associated therewith that is no longer in season (e.g., a stored value card containing seasonal images or product associated with a particular season) and to subsequently transport the product outside the defined coverage range (e.g., outside the perimeter) without triggering a signal notifying (e.g., alerting or warning) of potential fraud or theft of product. Once the product has been re-stocked to the location where the product is presented for retail, such as the home location (e.g., display structure functioning as the home base), the system can be configured to perform a digital “product check in” process in connection with the product that has entered (e.g., moves into) the defined coverage range and stocked to the location where the product is presented for retail.

As such, various examples of methods and systems identify product that is transported (e.g., carried by a consumer, or a thief or fraudster) outside a perimeter surrounding the location where the product is displayed for retail for a defined period of time without purchase of the product, for example at a point of sale device (or activation of the stored value product by a point of sale system), or reentering the perimeter. In some examples, the perimeter can be formed around the location where the product is displayed for sale, such as an endcap or display shelf among other display structures, and can define a coverage zone within which the location of the product can be detected/monitored for theft or fraud via the tag coupled to and linked with the product.

The methods and systems disclosed herein may be suitable for use in different theft monitoring applications, such as location-based monitoring of high value product susceptible to theft/fraud, as well as, for examples other products that are capable of being carried or concealed by a consumer. Stored value cards can include prepaid transaction cards, gift cards, and other stored value products. Stored value cards of high value are frequently targets of fraud because the stored value cards are fungible cards that can be converted or sold easily. For example, stored value cards of high value, such as transaction cards and gift cards, are susceptible to fraud that occurs by removing bulk quantities of cards from a retail location, tampering with the cards, and then returning the stored value cards to a retailer for subsequent purchase by an unsuspecting customer and activation by a point of sale system (e.g., a register). The fraudster only needs time and space (outside the store) to perpetrate fraud, especially in connection with stored value product (e.g., gift card or prepaid credit card). One or more systems and/or methods of this disclosure facilitate restricting or limiting this type of fraud. The examples disclosed herein can be implemented with hardware and software configured to provide a card processor with information associated with a stored value product that is located outside the defined coverage range (e.g., outside the perimeter) for at least the defined period of time without activation by purchase. In some non-limiting examples, the purchase can be carried out at a point of sale device of a point of sale system of the retailer, thereby allowing the card processor to prevent or “halt” activation/redemption of the stored value card. One or more examples also have the added advantage of stopping activation/redemption at retail without relying on the behavior of the cashier to mitigate or even eliminate fraud and monetary loss.

The methods and systems disclosed herein may be suitable for use in different tracking or monitoring applications having different types of sensors and tags. Some examples disclosed herein are implemented with passive (also includes labels) or semi-passive sensors and tags that allow for location monitoring of product within a defined area over time.

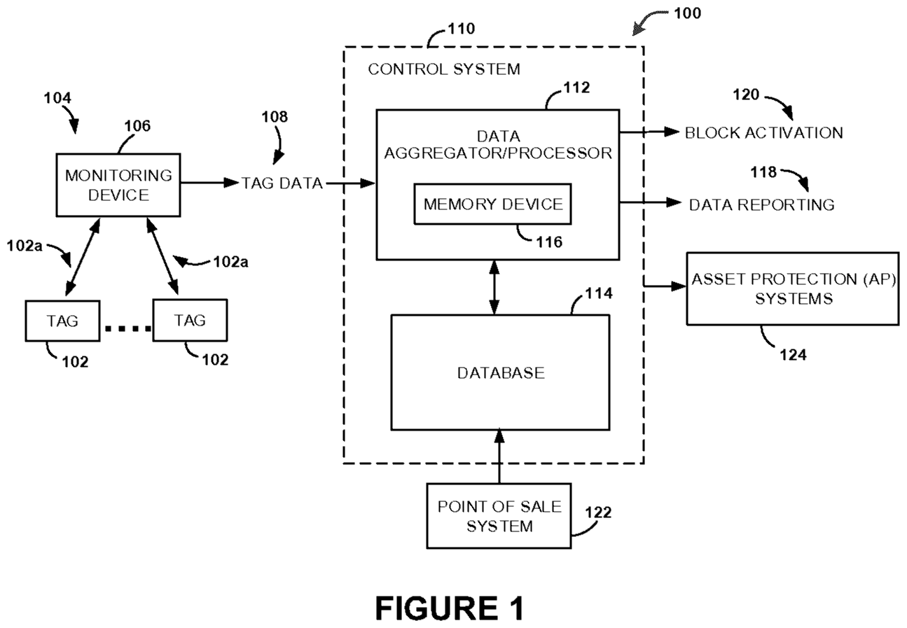

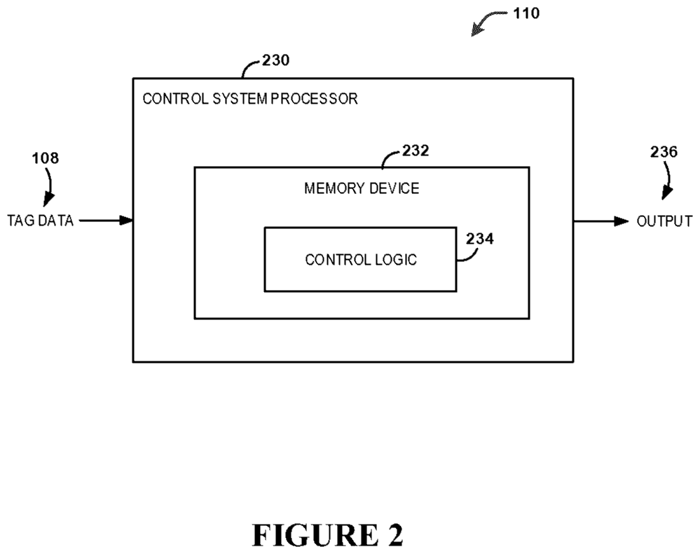

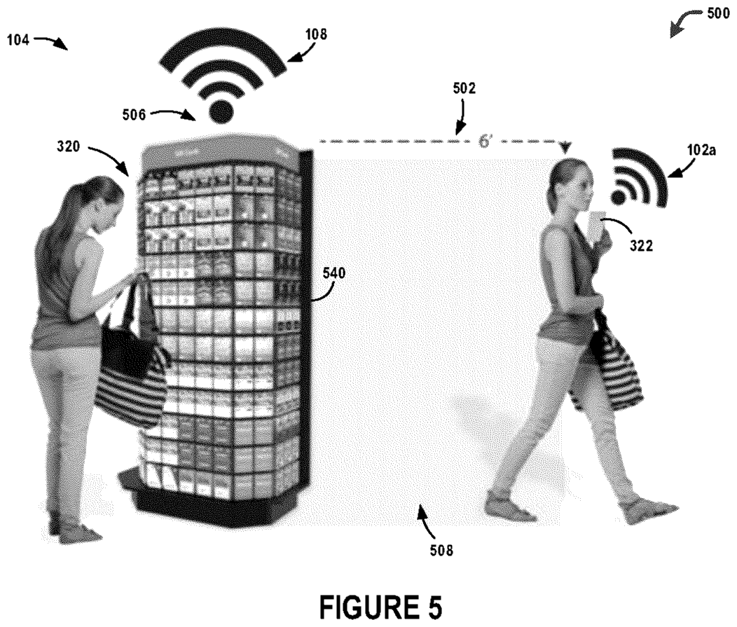

One or more implementations described herein provide a rules-based system for monitoring a product for theft or fraud. Referring now to FIGS. 1 and 2, there is provided a system 100 for monitoring a product, such as a stored value product, via a tag 102 that is coupled to and linked with the product. In various implementations, the system 100 is configured to identify a product having a tag associated therewith that is subject to fraud or theft by applying rules based on location and time. For example, the system 100 can apply the rules based on location and time to determine whether the product is stolen. With respect to the location-based rules and time-based rules, the product can be considered stolen (e.g., the subject of theft or fraud) when the product is removed from its retail display located inside the defined coverage range (e.g., 502, 602, 702 of FIGS. 5-7) of the monitoring device 106 (e.g., antenna 506, 606, 706 of FIGS. 5-7) and transported outside the defined coverage range, such that the product is located outside the defined coverage range (e.g., location-based rule) without the product (i) reentering the defined coverage range within a defined period of time (e.g., time-based rule) or (ii) being purchased, for example at a point of sale device such as a cash register of the retailer (or activated by a point of sale system 122 via purchase at the point of sale device), within the defined period of time (e.g., time-based rule). That is, the product may be considered stolen (e.g., the subject of theft or fraud) when the product is moved outside the defined coverage range and is then located outside the defined coverage range (e.g., outside the perimeter of the defined coverage range) for the entire period of time exceeding the defined time limit without purchase of the product. In some non-limiting examples, purchase of the product can occur at the point of sale device of the retailer (e.g., cash register). In some examples, the product is a stored value product, such as a stored value card, which can be activated by a point of sale system 122 via purchase at the point of sale device. In some examples, the retailer can set the defined time limit. In one or more examples, the defined time limit is two (2) hours, but it should be appreciated this disclosure is not limited to any particular time limit.

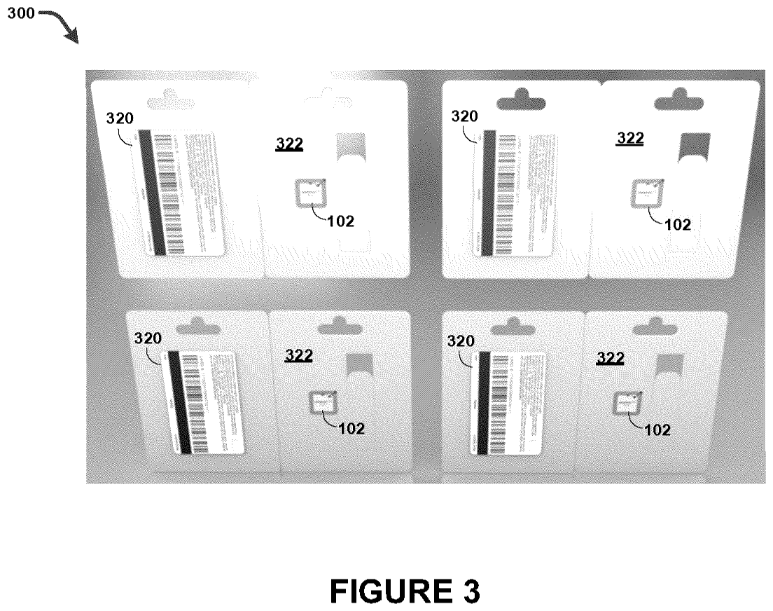

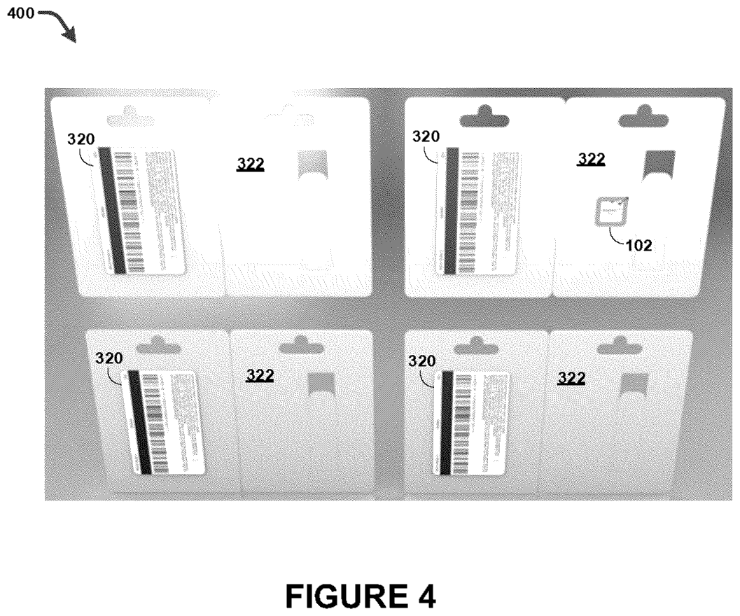

In some examples, the rules-based system (e.g., 100 of FIG. 1) can block activation of a stored value card (e.g., 320 of FIGS. 3 and 4) identified as stolen so that the stored value card cannot be redeemed for use. Halting activation/redemption of a stored value card can mitigate or prevent losses to a retailer resulting from theft of funds from the stored value card. In some non-limiting examples, a card processor can halt activation/redemption of the stored value card (e.g., gift cards, prepaid transaction cards, general purpose reloadable cards, debit cards, and any stored value cards that must be “activated” before they can be “redeemed” at retail).

With particular reference to FIG. 1, there is illustrated an example implementation of a system 100 for monitoring a product for theft or fraud via the tag 102 which is coupled to and linked with the product, and for reporting a product determined to be at risk of theft/fraud or considered stolen in order to mitigate losses connected to the theft or fraud. That is, the system 100 can be configured to monitor the product via the tag 102 that is coupled to and linked with the product (e.g., via the tag 102 associated with the product). In various implementations, the system 100 is configured to monitor the product (e.g., stored value product such as stored value card 320 of FIGS. 3 and 4) having a tag associated therewith, by monitoring the location of the tag 102 coupled to and linked with the product since the location of the tag 102 is indicative of the location of the product associated with the tag 102.

In various examples, the tag 102 is linked with the product via a unique identifier (e.g., unique identification (ID), such as a tag ID number) associated with the tag 102. In some examples, the system 100 can establish a unique electronic identity between the product (e.g., stored value card 320 of FIGS. 3 and 4) and the tag 102 that is coupled to the product, for example, by linking the tag 102 to the product using the unique identifier associated with the tag 102. In some examples, the product is a stored value product, such as a stored value card (e.g., 320 of FIGS. 3 and 4), and the tag 102 is linked with the stored value product via the unique tag identifier associated with the tag 102.

In one or more of these examples, the unique identifier associated with the tag 102 is linked to a unique card number associated with the stored value card thereby forming a digital/electronic link between the tag identifier and the card number that is stored in a data file. For example, in the system 100 the store value card (e.g., 320 of FIGS. 3 and 4) and the tag 102 associated therewith (e.g., the tag 102 coupled to and linked with the stored value card) may be stored in a data file, wherein the card number is paired with the tag identifier. In this way, the tag identifier points to (e.g., references) the specific card number the tag identifier is paired with in the data file. In some examples, the digital/electronic link formed between the tag identifier of the tag 102 and the card number of the stored value card (e.g., 320 of FIGS. 3 and 4) is stored in the data file during personalization of the stored value card. In some examples, the digital/electronic link between the tag identifier and the card number may be returned to a customer, such as to a data aggregator/processor 112, in a data file which enables the customer to identify the type and the value of a stored value card via the tag identifier associated therewith.

A tag can be selectively coupled to and linked with some but not all products of high value in order to save cost and reduce the complexity of implementation. In some examples, the product is a stored value card and a tag is coupled to and linked with each stored value card of high value (e.g., a value of at least $100) for monitoring the stored value card for theft. In other examples, a tag is selectively coupled to and linked with stored value cards of high value such that some but not all (e.g., a portion or subset) of the stored value cards of high value have a tag associated therewith. For example, a tag can be coupled to and linked with one out of every four stored value cards having a value of at least $100. This selective use of tags may be advantageous to save money but, conversely, is less accurate in detecting theft since not every stored value card has a tag associated therewith. As a result, theft is more likely to be detected during bulk theft of stored value cards (e.g., theft of multiple stored value cards at one time).

The tag 102 can be coupled to the stored value card (e.g., 320 of FIGS. 3 and 4) using any suitable means, and can be either directly (e.g., direct contact) or indirectly (e.g., no direct contact) coupled to the stored value card, and linked with the stored value card to monitor the location of the stored value card by monitoring the location of the tag 102 associated with the respective stored value card. For example, FIGS. 3 and 4 show a tag 102 affixed to a carrier 322 that secures a product (e.g., a stored value card 320) therein for purchase, as described below.

In some implementations, the tag 102 and the product (e.g., stored value card 320) are each secured to a surface of a carrier 322 configured to hold the product (e.g., stored value card 320) securely therein for display and transport. The tag 102 and product (e.g., stored value card 320) can be secured to a carrier 322 using any attachment means including, but not limited to, an adhesive. FIG. 3 shows one implementation of a tag configuration 300. In FIG. 3, each carrier 322 contains a stored value card 320 of high monetary value and a tag 102 secured to the carrier 322, and the tag 102 is coupled to and linked with the stored value card 320. This configuration allows for monitoring of each high-value stored value card for potential theft. In other examples, a tag may be selectively applied to some but not all carriers (e.g., a portion or subset of carriers 322) that contain a stored value card of high monetary value such that only a portion of the carriers 322 include a tag coupled to and linked with a stored value card of high value.

FIG. 4 shows another implementation of a tag configuration 400 in which some but not all carriers 322 containing a stored value card 320 of high value (e.g., value of at least $100) also contain a tag 102. In FIG. 4, one out of every four carriers 322 contain a stored value card 320 of high value and a tag 102 attached to the carrier 322 with the tag 102 coupled to and linked with the stored value card 320 of high value. From the above examples, it should be appreciated a tag can be coupled to and linked with a stored value product at periodic (e.g., repeating) intervals or at random. The selective use of tags to monitor products may be advantageous to save money and material because it requires fewer tags to monitor the product. But, one drawback of using fewer tags to monitor product is that some high-value product is not associated with a tag and cannot be independently (directly) monitored for theft. Thus, fewer tags reduces the probability of detecting theft since not every product has a tag coupled thereto and linked therewith and, as a result, theft is more likely to be detected in cases of bulk theft of product (e.g., theft of multiple products at one time).

In some examples, the carrier 322 is an envelope that can be folded and sealed along one or more sides of the envelope, as illustrated in FIGS. 3 and 4. In one non-limiting example, the stored value card 320 is packaged in a carrier 322 comprising a folding envelope that is sealed on all four sides. The tag 102 can be placed on the interior of the carrier 322, such as on an interior surface of the envelope adjacent to the stored value card 320, as illustrated in FIGS. 3 and 4. In some examples, the tag 102 is disposed on or in the carrier 322 with the tag 102 concealed from view. One advantage of a concealed tag 102 is that a person and, more specifically a thief or fraudster, will be unaware of the presence of the tag 102 unless the person tampers with the carrier 322 in a manner that exposes the tag 102.

In other implementations, the tag 102 may be attached to the stored value card 320 itself, such as to a surface of the stored value card 320. In still other implementations, the tag 102 may be embedded in or otherwise incorporated in (built-in) the stored value card 320.

The tag 102 can be any suitable tag, label, or sensor configured to transmit data associated with the tag, the data comprising at least location data associated with the tag 102. In some examples, the tag 102 may be configured to transmit a unique tag identifier associated with the tag when queried or activated/powered by another device such as, for example, a monitoring device 106. It should be appreciated the tag 102 can be applied in different configurations and numbers as desired or needed. The tag 102 may comprise a passive device, semi-passive device, or active device that allows for location monitoring of product located within a defined coverage range over a defined period of time (or time interval). For example, the tags (e.g., 102 of FIG. 1) can be different types of tags or sensors, such as passive RFID tags, active RFID tags, semi-passive RFID tags, or BLE sensors, among others.

In various examples, the tag 102 is a passive device having a unique identifier associated therewith. In some examples, the tag 102 is a simple “license plate” tag that can be monitored within a certain range (e.g., distance). In some examples, the tag 102 is a passive RFID tag (e.g., RAIN RFID tags). In these examples, the monitoring system 104 may further comprise a RFID tag reader to read the RFID tag located within the defined coverage range (e.g., inside communication range or communication distance) of the RFID tag reader. Each of these examples provides a low cost implementation with sufficient functionality for the monitoring system 104 to monitor the product for theft by monitoring the location of the tag 102 associated therewith and subsequently to provide tag data 108 to the system 100 and, more specifically to the control system 110, for managing tag data and determining, based on the received tag data 108, whether the product is the subject of theft or fraud.

In various implementations, the tag 102 can comprise a semi-passive device or an active device for monitoring the location of the stored value card 320. In some examples, the tag or sensor may be a Bluetooth low-energy (BLE) sensor. When tag is a BLE sensor, the monitoring system 104 may further comprise a receiver or a gateway configured to communicate with the BLE sensor. In some implementations, the tag 102 can comprise a location tracking tag that is configured to acquire location data has a unique identifier associated therewith, and can include additional functionality. These implementations are generally less cost effective due to the higher costs associated with the increased functionality of the semi-passive and active devices, for example, because the tags have more storage space, increased communication capabilities, an independent power source among other things.

In operation, in some examples, the tag 102 is configured to transmit data (e.g., 102a of FIG. 1) associated with the tag 102. The transmitted data (e.g., 102a of FIG. 1) at least comprises location data associated with the tag 102. The location of a tag 102 is indicative of the location of a product that is coupled to and linked with the tag 102. In some examples, a tag 102 is linked with a product using a unique identifier associated with the tag 102 so that data transmitted by the tag 102 is indicative of the location of the product associated therewith. In this way, the system 100 can be used to monitor a location of a product for potential theft by monitoring a location of the tag 102 coupled to and linked with the product. That is, the system 100 can monitor a product for theft by monitoring the location of the tag associated with the product, for example, to determine when the product is located outside a defined coverage range (e.g., outside a perimeter surrounding the location where the product is displayed for sale) for a period of time that exceeds a defined time limit as described herein. In some examples, the system 100 can monitor a product for theft by monitoring the location of the tag 102 that is coupled to and linked with the product, wherein the tag 102 located outside the defined coverage range (e.g., outside the perimeter surrounding the location where the product is displayed for sale) indicates the product associated with the tag 102 is located outside the defined coverage range.

In various implementations, the system 100 further comprises a control system 110 operable for monitoring a product, such as a stored value product of high monetary value (e.g., a stored value card 320 of FIGS. 3 and 4), that is coupled to and linked with a tag 102 via a unique identifier associated with the tag 102. In some implementations, the control system 110 comprises a data aggregator/processor 112 and a database 114 operatively coupled with the data aggregator/processor 112.

Referring now to FIG. 2, there is illustrated an example implementation of the control system 110 of system 100 of FIG. 1. In various examples, the control system 110 can comprise a control system processor 230 (e.g., processing machine, service device, etc.), a non-transient memory device 232 operatively coupled with the control system processor 230, and control logic 234 stored in the non-transient memory device 232. The non-transient memory device 232 can be configured to store tag data (e.g., tag data 108 received by control system 110 of FIG. 1) associated with the tag 102 indicating the product associated with the tag 102 (e.g., coupled to and linked with the tag 102) is located outside a defined coverage range. In some examples, the product can have a tag 102 associated therewith and the tag data associated with the tag 102 can indicate the product is located outside a defined coverage range of a monitoring device (e.g., antenna). The non-transient memory device 232 can be further configured to store a defined time limit the product is permitted to be located outside the defined coverage range. In some examples, the defined time limit is a time interval the product is permitted to be located outside the defined coverage range without purchase from the retailer, for example, at a point of sale device (e.g., cash register) of the retailer. In some examples, the defined time is a time interval the product is permitted to be located outside the defined coverage range without purchase from the retailer or reentry into the defined coverage range. In some examples, the non-transient memory device 232 may be further configured to store the link between the card number of a stored value card and the tag identifier of the tag 102. In some examples, the control logic 234 stored in the non-transient memory device 232 is executable by the control system processor 230 to determine, based on the tag data 108, whether the period of time the product has been located outside the defined coverage range exceeds the defined time limit. In some non-limiting examples, the determined period of time consists of a continuous period of time the product has been located outside the defined coverage range without reentering the defined coverage range or being purchased. In these examples, the control logic 234 stored in the non-transient memory device 232 is further executable by the control system processor 230 to, in response to the determined period of time exceeding the defined time limit, access the database 114 storing data identifying a product that has been purchased. In some examples, the data identifying products that have been purchased is point of sale data provided to the database by a point of sale device. In these examples, the point of sale data is provided to the database 114 by a point of sale device (e.g., the cash register of the retailer). Additionally, the control logic 234 stored in the non-transient memory device 232 is further executable by the control system processor 230 to determine, based on the data (e.g., stored point of sale data) identifying products that have been purchased, whether the product has been purchased.

The control system processor 230 in one example is a processing machine that can be used in combination with one or more other systems (e.g., monitoring system 104) to analyze tag data 108 and generate outputs 236 for determining whether product is the subject of theft or fraud. More particularly, the control system 110 includes the control system processor 230 that is configured as a processing engine that performs product location/tracking analysis using tag data 108 associated with the tag 102 coupled to and linked with the product that is located outside the defined coverage range (e.g., outside the perimeter). In some examples, the tag data 108 is obtained via one or more tracking devices.

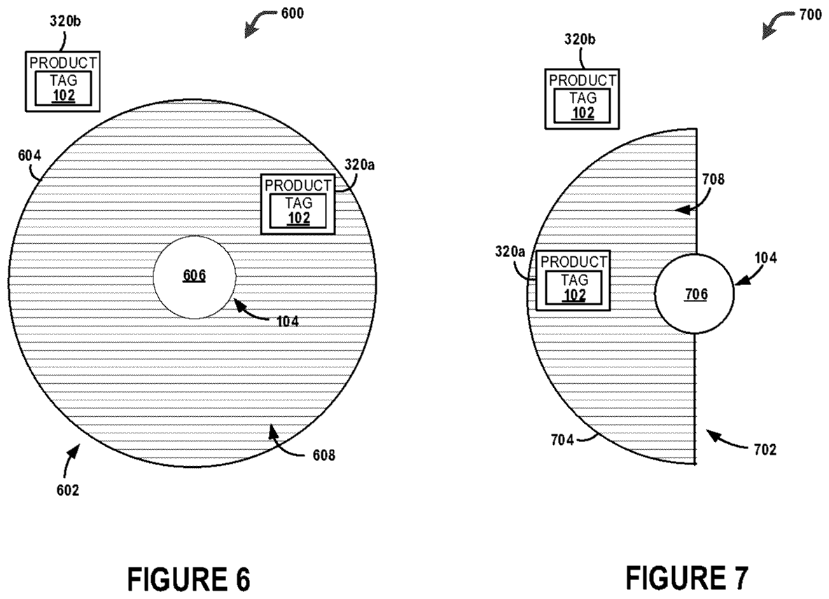

In various examples, the control system 110 is configured to receive, from a monitoring system 104, tag data 108 associated with a tag 102 that is coupled to and linked with a product, where the tag data 108 is indicative of at least a location of the tag 102 and the location of the tag 102 is indicative of the location of the product having the tag 102 associated therewith. In some examples, the control system 110 is configured to receive, from a monitoring device 106 (e.g., antenna), tag data 108 associated with a tag 102 that is located outside a defined coverage range (e.g., communication range) of the monitoring device 106, such that the tag 102 is missing from the defined coverage range and can be referred to as a “missing tag”. In one or more of these examples, the monitoring device 106 is an antenna. In these examples, the control system 110 can receive, from the antenna (e.g., 506, 606, 706 of FIGS. 5-7), tag data 108 associated with a tag 102 that is not detected (e.g., is not visible to) by the antenna within (inside) the defined coverage range (e.g., 508, 608, 708 of FIGS. 5-7) of the antenna. This tag 102 is considered to be located outside the defined coverage range and is also known as a missing tag. In some of these examples, the control system 110 can receive, from the antenna, tag data 108 associated with the tag 102 (e.g., the missing tag) that is coupled to and linked with the product located outside the defined coverage range of the antenna or, stated another way, the product is located outside a perimeter that surrounds the antenna and delineates the outer periphery of the defined coverage range. The product coupled to and linked with the tag (e.g., the missing tag) located outside the defined coverage range of the antenna (e.g., outside the perimeter), is thus located outside the defined coverage range. That is, the product associated with the missing tag can be referred to as a “missing product” (e.g., 320b of FIGS. 6 and 7). A missing product indicates a product that is at risk of theft or fraud. The control system 110 can receive tag data 108 associated with a missing tag 102 (e.g., a tag 102 located outside the defined coverage range), wherein the tag data 108 indicates the product coupled to and linked with the missing tag 102 is located outside the defined coverage range (e.g., is a missing product 320b of FIGS. 6 and 7) and potentially the subject of fraud or theft.

In these examples, the product has a tag 102 associated therewith and the control system 110 can be configured to determine, based on the received tag data 108 associated with a tag 102 (e.g., a missing tag), whether the product coupled to and linked with the tag 102 has been located outside the defined coverage range (e.g., outside the perimeter delineating the outer periphery of the defined coverage range) for a period of time exceeding a defined time limit without purchase. In one or more examples, the determined period of time consists of a continuous period of time the product has been located outside the defined coverage range without reentering the defined coverage range (e.g., moving inside the perimeter) or being purchased. In some examples, the product that reenters the defined coverage range during the defined time limit is not considered by the control system 110 to be the subject of theft or fraud, and thus the product is deemed by the control system 110 to be safe for purchase. The control system 110 can be further configured to determine, based on the data identifying products that have been purchased (e.g., stored point of sale data), whether the product has been purchased, such as at a point of sale device of the retailer (e.g., a cash register), during the defined time limit. In some examples, the control system 110 can mitigate or prevent theft of stored value cards by blocking activation of stored value cards determined to have been located outside the defined coverage range for the period of time exceeding the defined time limit without subsequent reentry into the defined coverage range or activation of the stored value card, such as via purchase of the stored value card. If so, the control system 110 may be configured to generate a signal 120 blocking subsequent activation, use, or redemption of the stored value card. Additionally or alternatively, the control system 110 may be configured to generate a signal 118 reporting specific stored value product at risk of (e.g., potentially the subject of) theft or fraud.

In various examples, the control system 110 can be operatively coupled to one or more asset protection (AP) systems 124 such that the control system 110 can communicate with the one or more AP systems 124. In these examples, the control system 110 can be configured to generate a signal notifying (or alerting) the AP systems 124 of a potential theft or fraud incident related to a product that has been located outside the defined coverage range for a period of time exceeding the defined time limit without being purchased. In some examples, the AP system 124 can be configured to catalog/bookmark the theft or fraud incident and indicated when the particular fraud or theft was detected. In one or more examples, the AP system 124 can be configured to catalog/bookmark the theft or fraud incident by generating a timestamp indicating when (e.g., the specific time and date) the particular fraud or theft occurred. The AP system 124 can be configured to collect video and other data corresponding to the specific time period the fraud or theft was determined by the control system 110. That is, the AP system 124 can be configured to collect video, images, and other data corresponding to the time period of the theft or fraud incident determined by the control system 110, for example, by acquiring data beginning a period of time (e.g., user defined) just prior to the detected theft or fraud incident to a period of time shortly after the detected theft or fraud incident (e.g., user defined). In some examples, the collected video, images, and other data corresponding to the time period of the suspected theft or fraud incident can be stored in a data storage device for later review by law enforcement personnel. In some examples, the one or more AP systems 124 can comprise or otherwise be configured to utilize facial recognition systems to identify customers suspected of theft or fraud. Further, the one or more AP systems 124 can acquire and subsequently store video and images captured by internal and external cameras and subsequently store the captured data associated with the incident, such as the license plate and model of the vehicle used in the commission of the crime by the suspected thief or fraudster.

The monitoring system 104 can be further configured to provide data associated with the tag 102 (e.g., tag data 108) to the control system 110 via direct or indirect communication with the control system 110. In some examples, the control system 110 is configured to receive, from the monitoring system 104, tag data 108 associated with the tag 102 whose location or change in location indicates that the product having the tag 102 associated therewith is at risk of theft or fraud. In this way, the control system 110 can receive, from the monitoring system 104, a signal representative of the identity of the tag (e.g., tag data 108), for example the unique tag identifier associated with the tag 102, whose location or change in location indicates that the product associated with the tag 102 potentially is the subject of theft or fraud.

In some examples, the monitoring device 106 is configured to monitor the location of the product by monitoring the location of the tag 102 that is coupled to and linked with the product as described herein, since the location of the tag 102 is indicative of the location of the product associated therewith. The monitoring device 106 can be further configured to provide tag data 108 comprising at least data indicative of the location of the tag 102, to the control system 110 as described herein. For example, the monitoring device 106 can be configured to receive location data associated with the tag 102 and to transmit the tag data 108 to the control system 110. In various examples, the control system 110 is configured to receive, from the monitoring device 106, the tag data 108 comprising at least data indicative of the location of the tag 102. In one or more examples, the monitoring device 106 is configured to provide tag data 108 to the control system 110 relating to a tag 102 whose location (or change in location) indicates the product associated with the tag 102 is at risk of theft or fraud. In this way, the control system 110 can receive, from the monitoring device 106, a signal representative of the identity of the tag (e.g., tag data 108) whose location (or change in location) indicates the product associated with the tag 102 is at risk of theft or fraud. In some examples, the monitoring device 106 is operatively coupled with the control system 110. In these examples, the monitoring device 106 can be configured to transmit tag data 108 associated with the tag 102 as part of a digital “product check in” and “product check out” process in connection with the product that is coupled to and linked with the tag 102, for example, via the unique tag identifier associated with the tag 102 as described below.

In some examples, the monitoring device 106 is further configured to detect a product replenishment device used to re-stock (e.g., replenish or replace) products, including products having a tag 102 associated therewith, when the product replenishment device is located inside the defined coverage range by identifying the location of an asset tag (e.g., a passive device, semi-passive device, or active device) assigned to the product replenishment device. The asset tag can be coupled to the product replenishment device (e.g., a cart) and configured to communicate with the monitoring device 106. In some examples, the monitoring device 106 is configured to detect the asset tag assigned to the product replenishment device when the product replenishment device is located inside the defined coverage range and to provide asset data comprising data indicative of the location of the asset tag to the control system 110. That is, the monitoring device 106 is further configured to detect when the product replenishment device is located within the defined coverage range via the asset tag coupled thereto, for example, when the product replenishment device is moved inside the defined coverage range (e.g., inside the perimeter) to replenish and/or replace product. In some examples, the monitoring device 106 can be configured to receive location data associated with the asset tag and to transmit the asset tag data to the control system 110.

In various examples, the control system 110 is configured to receive, from the monitoring device 106, the asset tag data comprising data indicative of the location of the product replenishment device associated with the asset tag and indicating (signaling) a re-stocking event where product is added and/or removed from the display structure located inside the defined coverage range. In some non-limiting examples, the monitoring device 106 is further configured to detect when a product having a tag 102 associated therewith is removed from the display structure located inside the defined coverage range and functioning as a home base (home location).

In some of these implementations, the system 100 can be configured to enter a re-stocking mode (also referred to as a replenishment state) permitting store personnel to remove product having a tag associated therewith, from the home base (e.g., display structure serving as the home location), and to subsequently transport the product to a location outside the defined coverage range (e.g., outside the perimeter) without triggering an alert/warning of potential risk of theft or fraud. In one or more implementations, the control system 110 is configured to enter the re-stocking mode (the replenishment state) permitting store personnel to remove product having a tag associated therewith, from the home base (e.g., display structure serving as the home location), and to subsequently transport the product to a location outside the defined coverage range (e.g., outside the perimeter) without triggering an alert/warning of potential risk of theft or fraud; that is, without causing generation of a signal notifying (e.g., alerting or warning) of potential fraud or theft of product. In one or more implementations, the re-stocking mode (or replenishment state) is a predefined mode/state that may be a factory preset or a user-defined setting. For the purpose of illustration and not limitation, the system 100 and, in particular implementations the control system 110, may enter the re-stocking mode (the replenishment state) permitting store personnel to remove product from the home location (e.g., display structure) that is no longer in season, such as a stored value card containing seasonal images or other product specifically tied to a particular season of use, and to subsequently transport the product outside the defined coverage range (e.g., outside the perimeter) without triggering generation of a signal notifying (e.g., alerting or warning) of potential fraud or theft of product.

In some implementations, the monitoring device 106 comprises a gateway, such as a tag reader (interrogator) or a receiver, and an antenna operatively coupled with the gateway and configured to facilitate communication between the tag, the gateway (e.g., tag reader), and the control system 110. In particular implementations, the antenna is in operative electrical communication with the gateway.

Referring now to FIGS. 5 through 7, and with continued reference to FIG. 1, there is illustrated an example implementation of a system 500 for monitoring product (e.g., stored value product such as stored value cards 320) and reporting potential fraud and/or theft of the product. In various examples, the monitoring device 106 is an antenna 506, 606, 706 configured to monitor a product (e.g., stored value product, such as stored value card 320), such as the location of the product, by monitoring the location of the tag 102 coupled to and linked with the product (e.g., stored value product such as stored value card 320). In some examples, the antenna 506, 606, 706 is configured to transmit a signal (e.g., tag data 108) representative of the identity of a tag 102 that is no longer visible to the antenna 506, 606, 706. Stated another way, the antenna 506, 606, 706 is configured to transmit a signal (e.g., tag data 108) representative of the identity of the tag 102 that is no longer detected by the antenna 506, 606, 706, and thus the product (e.g., stored value product such as stored value card 320) associated with the tag 102 is deemed to be located outside the defined coverage range 502, 602, 702 (e.g., outside the communication range) of the antenna 506, 606, 706 and at risk of theft or fraud.

In various examples, the antenna 506, 606, 706 has a defined coverage range 502, 602, 702 extending outward a fixed distance from (e.g., away from) the antenna 506, 606, 706 and defining a communication range of the antenna 506, 606, 706 in terms of distance. The antenna 506, 606, 706 can communicate with a tag 102 located within the defined coverage range (e.g., inside the communication range or distance). That is, the communication range of the antenna 506, 606, 706 represents a distance, measured with respect to the antenna 506, 606, 706, over which the antenna 506, 606, 706 can communicate with a tag 102. It should be appreciated the defined coverage range 502, 602, 702 is an inherent characteristic of the particular type of antenna, which can be modified according to the particular application. In some examples, the defined coverage range 502, 602, 702 may be further defined by a user according to the particular application. For example, the size (e.g., fixed distance) of the defined coverage range and/or the shape (configuration) of the defined coverage range can be adjusted by changing the type and/or size of the antenna among other things. Thus, the fixed distance of the defined coverage range is a finite (close-ended) distance that represents the maximum distance the defined coverage range can extend from the antenna (i.e., the communication range in terms of distance).

In some non-limiting examples, the defined coverage range 502, 602, 702 extends outward a distance of about twenty (20) feet from the antenna 506, 606, 706, thereby defining the communication range of the antenna 506, 606, 706 in terms of distance. In the example shown in FIG. 5, the antenna 506 has a defined coverage range 502 that extends outward a distance of about six (6) feet from (e.g., away from) the antenna 506. But, it should be appreciated that the defined coverage range can extend outward other distances from the antenna in accordance with this disclosure, such as eight (8) feet, twelve (12) feet, or fifteen (15) feet, and the illustrated distance of six (6) feet is merely for the purpose of example and not limitation. Generally, the defined coverage range 502, 602, 702 extends outward a distance from the antenna 506, 606, 706 between six (6) feet and twenty (20) feet.

In some implementations, the defined coverage range 602 extends radially outward (e.g., away) a fixed distance from the antenna 606 in all directions and thus defines a perimeter around the antenna 606. The perimeter 604 is disposed at the outer periphery (or outermost edge) of the defined coverage range 602 at the fixed distance (e.g., the maximum distance) from the antenna 606 and represents a communication boundary of the antenna 606. In some implementations, the fixed distance is adjustable and can be defined by a user. FIG. 6 shows an example implementation of a system 100 for monitoring product (e.g., stored value product such as stored value card 320), detecting/identifying suspected fraud and/or theft of the product, and reporting the potential fraud and/or theft of the product, where the perimeter 604 entirely surrounds the antenna 606 of the monitoring system 104. More specifically, the perimeter 604 encircles the antenna 606 of the monitoring system 104 and defines a coverage zone 608 where the antenna 606 can communicate with a tag 102. That is, a perimeter 604 is disposed at the outer periphery (outer edge) of the defined coverage range 602 some fixed distance from the antenna 606, wherein the perimeter 604 surrounds the antenna 606 and represents a communication boundary. The antenna 606 can communicate with the tag 102 located inside the perimeter 604 (e.g., inside the communication boundary), for example, within the coverage zone 608 defined by the perimeter 604. But, the antenna 606 cannot communicate with the tag 102 located outside the perimeter 604 (e.g., outside the communication boundary).

In some implementations, the defined coverage range 702 extends radially outward (e.g., away) a fixed distance from the antenna 706 in some but not all directions, and defines a perimeter 704 that extends around a portion of the antenna 706 but not all of the antenna 706. The defined coverage range of an antenna is not limited to a specific shape and can be configured/manipulated to assume different shapes. In FIG. 7, the perimeter 704 is disposed at the outer periphery (e.g., outermost edge) of a defined coverage range 702 and the fixed distance from the antenna 706 and has a semicircle shape. The perimeter 704 represents a communication boundary the antenna 706. That is, FIG. 7 shows an example implementation of a system 100 for monitoring product (e.g., stored value product such as stored value card 320), detecting/identifying suspected fraud and/or theft of the product, and reporting the potential fraud and/or theft of the product, where the perimeter 704 is a semicircle and only surrounds a portion of the antenna 706 of the monitoring system 104. More specifically, the perimeter 704 defines a coverage zone 708 that is shaped as a semicircle and the antenna 706 can communicate with a tag 102 located inside the coverage zone 708. That is, the perimeter 704 has a semicircle shape with the perimeter 704 disposed at the outer periphery (outer edge) of the defined coverage range 702, wherein the perimeter 704 surrounds a portion of the antenna 706 and represents a communication boundary where the antenna 706 can communicate with a tag 102 located inside the perimeter 704 (e.g., inside the communication boundary), for example, within the semicircular coverage zone 708 defined by the perimeter 704. But, the antenna 706 cannot communicate with a tag 102 located outside the perimeter 704 (e.g., outside the communication boundary).

FIGS. 6 and 7 illustrate example implementations that comprise an antenna 606, 706 configured to monitor a location of the product 320a (e.g., stored value product) via a tag 102 that is coupled to and linked with the product 320a since location data 102a associated with the tag 102 (e.g., the location of the tag) is indicative of the location of the product 320a associated therewith. In operation, the antenna 606, 706 can communicate with a tag 102 that is located inside the perimeter 604, 704 (e.g., in the coverage zone 608, 708) for the purpose of monitoring the product 320a via the tag 102 that is coupled to and linked with the product 320a. That is, the antenna 606, 706 has a defined coverage range 602, 702 and the antenna 606, 706 can communicate with a tag 102 that is located within the defined coverage range 602, 702 of the antenna 606, 706, such as the tag 102 located inside the perimeter 604, 704 in the coverage zone 608, 708, to monitor the location of the product 320a (e.g., stored value product) by monitoring the location of the tag 102 associated therewith.

In various examples, the antenna 506, 606, 706 is configured to communicate with a tag 102 that is located within a defined coverage range 502, 602, 702 of the antenna 506, 606, 706 to receive data associated with the tag 102 (e.g., location data 102a). In some examples, the antenna 506, 606, 706 monitors the location of a product (e.g., stored value product such as stored value card 320) via the tag 102 associated with the product (e.g., stored value product such as stored value card 320) since location data 102a associated with the tag 102 is indicative of the location of the product (e.g., stored value product such as stored value card 320) that is coupled to and linked with the tag 102. It should be appreciated the defined coverage range of an antenna is based on the type of antenna and may be modified by a user to suit a particular application. For example, the antenna can be selected and configured based on the type of tag being used, the characteristic coverage range (i.e., communication range or communication distance) of the antenna, and/or the overall use environment.

In various examples, an antenna 506, 606, 706 is disposed relative to a location where a product (e.g., stored value product such as a stored value card 320) is displayed for sale. In some examples, the antenna 506, 606, 706 is disposed relative to a display structure (e.g., display shelf or endcap) where the product is physically located and/or presented for sale. FIG. 5 shows an antenna 506 disposed relative to a display 540 (e.g., endcap) where products (e.g., stored value cards 320) are physically located and presented for sale. In some examples, the antenna 506 is incorporated or otherwise integrated into the display 540, as shown in FIG. 5. For example, the antenna 506 may be embedded in the display 540 or otherwise disposed inside the display 540 (e.g., inside a cavity in the interior of the display) thereby forming an integrated display module (or integrated display structure) that is configured to display the products (e.g., stored value products like stored value cards 320) for sale. In some examples, the antenna 506, 606, 706 is attached to or mounted on an exterior surface of the display 540. For example, the antenna may be mounted on top of the display 540 with the antenna located above the display 540. In some examples, the antenna 506, 606, 706 is disposed above the display with the antenna 506, 606, 706 attached to or mounted on an external structure in proximity to the display. For example, the antenna may be mounted to a support structure located directly above the display containing the products. In one particular example, the antenna may be suspended from a ceiling over the display so as to be disposed relative to the display. It should be appreciated that the display structure may contain metal panels that can interfere with wireless electronic communication (e.g., wireless signaling). These metal panels may be replaced by panels made of another material, such as wood, which permit penetration/transmission of electronic signals therethrough. Alternatively, the metal panels may be modified to ensure signal transmission/penetration, such as by drilling holes through the metal panels.

In these examples, the antenna is disposed relative to the display and includes a defined coverage range that extends radially outward (e.g., away) a fixed distance from the antenna 606. The defined coverage range of the antenna effectively forms a perimeter disposed at the outer periphery (outer edge) of the defined coverage range 602 some fixed distance from the antenna 606 that surrounds both the antenna and the display, where the perimeter represents a communication boundary of the antenna. For example, the antenna 606 can communicate with a tag 102 located inside the perimeter 604 (e.g., inside the communication boundary), for example, within the coverage zone 608 defined by the perimeter 604. But, the antenna 606 cannot communicate with a tag 102 located outside the perimeter 604 (e.g., outside the communication boundary). In effect, disposing the antenna 506, 606, 706 relative to the display where the product (e.g., stored value product such as stored value card 320) is located and presented for sale enables the display to function as a home base for the product.

In various examples, the monitoring device 106 (e.g., antenna) is configured to receive data, such as location data, associated with the tag 102 and to transmit data associated with the tag (e.g., tag data 108) to the control system 110 comprising data indicative of the location of the product associated with the respective tag 102 as part of a digital “product check in” and “product check out” processes. In some examples, a monitoring device 106 (e.g., antenna 506, 606, 706) can be disposed relative to the display structure where the product (e.g., stored value product such as stored value card 320) is displayed for sale (e.g., the product home base) and configured to perform digital “check in” of a product when a tag 102 associated with the product enters into (e.g., moves into) the defined coverage range of the monitoring device 106 (e.g., antenna) such as, for example, when the product is placed on the display structure (e.g., endcap) for retail. In one or more examples, the antenna can be configured to perform a digital “check in” of the product that is coupled to and linked with the respective tag 102 that enters (e.g., moves into) the defined coverage range of the antenna. That is, the antenna “checks in” the product when the tag associated with the product is detected by the antenna—for example, the tag is located inside the perimeter surrounding the antenna (e.g., inside the communication boundary) in the coverage zone 608. In some examples, the antenna can transmit tag data 108 associated with the tag 102 to the control system 110 to record a unique electronic identity associated with the product (e.g., stored value product such as stored value card 320 of FIGS. 3 and 4) coupled to and linked with the tag 102, particularly when the product (e.g., stored value card 320 of FIG. 5) is displayed for retail. In this way, an electronic bond or electronic tether can be formed between the product (e.g., stored value card 320) and the display 540 (e.g., display structure such as an endcap, shelf, platform, etc.) where the product (e.g., stored value card 320) is physically located and presented for sale by the retailer.

In some examples, the monitoring device 106 (e.g., antenna 506, 606, 706) can be configured to perform digital “check in” of product having a tag 102 associated therewith, when the product is stocked to the display location or display structure inside the defined coverage range of the monitoring device 106 (e.g., antenna). In one or more examples, the monitoring device 106 (e.g., antenna 506, 606, 706) can be configured to perform digital “check in” of product having a tag 102 associated therewith (e.g., a tag 102 coupled to and linked with the product) once re-stocking and replenishing of the display structure with the product is completed. That is, the monitoring device 106 (e.g., antenna) “checks in” the product by transmitting tag data 108 associated with the tag 102 to the control system 110 to record a unique electronic identity associated with the product (e.g., stored value product such as stored value card 320 of FIGS. 3 and 4) coupled to and linked with the tag 102, particularly after replenishing the location (e.g., display structure that functions as the home location/base) where the product is displayed for retail. In this way, an electronic bond or electronic tether can be formed between the product (e.g., stored value card 320) and the display 540 (e.g., display structure such as an endcap, shelf, platform, etc.) where the product (e.g., stored value card 320) is physically located and presented for sale by the retailer.

In some examples, the control system 110 is configured to receive, from the monitoring system 104, tag data 108 associated with the tag 102. In these examples, the control system 110 can receive, from the monitoring system 104 (or monitoring device 106 (e.g., antenna)), data indicative of the location of the product associated with the tag 102 that is respectively stocked to the location (e.g., display structure that functions as the home location/base) where the product is presented for retail located inside the defined coverage range (e.g., inside the perimeter), as part of a digital “product check in” process. In some examples, the monitoring device 106 (e.g., antenna) is configured to transmit tag data 108 associated with a tag 102 to the control system 110 to record a unique electronic identity associated with a product (e.g., a stored value product such as stored value card 320) that is coupled to and linked with the tag 102 once the display structure (home base) has been re-stocked/replenished with product (e.g., a stored value product such as stored value card 320) for retail as part of the “check in” process. For example, the monitoring device 106 (e.g., antenna) is configured to “check in” a product that is coupled to and linked with a tag, when the product is placed on the display structure at the retail location and presented for sale, preferably after the replenishment/re-stocking has been completed. In this way, an electronic bond or tether is formed between the product (e.g., stored value card 320) and the display 540 (e.g., display structure such as an endcap, shelf, platform, etc.) where the product (e.g., stored value card 320) is physically located and presented for sale by the retailer.

That is, the antenna can be configured to perform digital “check in” of a product associated with a tag 102 that is detected, by the antenna, as located inside the defined coverage range of the antenna (e.g., located inside the perimeter surrounding the antenna). In some examples, the antenna (e.g., monitoring device 106) is configured to transmit tag data 108 associated with a tag 102 to the control system 110 to record a unique electronic identity associated with a product (e.g., stored value card 320) that is coupled to and linked with the tag 102 when the product (e.g., stored value card 320) is displayed for retail as part of the “check in” process. For example, an antenna can be configured to perform a digital “check in” of a tag 102 that enters (e.g., moves into) a defined coverage range of the antenna. That is, the antenna is configured to perform a digital “check in” of a tag 102 that is detected, by the antenna, as being located inside the perimeter surrounding the antenna (e.g., inside the communication boundary), for example, within the coverage zone 608 defined by the perimeter 604. In some examples, the antenna (e.g., monitoring device 106) is configured to transmit tag data 108 associated with a tag 102 to the control system 110 to record a unique electronic identity associated with a product (e.g., stored value card 320) that is coupled to and linked with the tag 102 when the product (e.g., stored value card 320) is displayed for retail as part of the “check in” process. In some examples, the antenna can transmit tag data 108 to a control system 110. In this way, an electronic bond or tether is formed between the product (e.g., stored value card 320) and the display 540 (e.g., endcap) where the product (e.g., stored value card 320) is physically located and presented for sale by the retailer. In this way, the data aggregator/processor 112 is capable of identifying which products (e.g., stored value product like stored value cards 320) are stocked to a particular merchant/retail location using the unique electronic identity associated with the product (e.g., stored value product like stored value cards 320). For example, the antenna is configured to “check in” a product that is coupled to and linked with a tag, when the product is placed on the display structure at the retail location and presented for sale.

In various examples, the antenna (e.g., 106 of FIG. 1) can be configured to transmit data associated with the tag 102 (e.g., tag data 108) to the control system 110 as part of a “product check in” process. In some examples, the antenna (e.g., 106 of FIG. 1) can transmit tag data 108 associated with the tag 102 to the control system 110 so that the control system 110 records the unique electronic identity associated with the product coupled to and linked with the respective tag when the product is placed on the display 540 for retail. In this way, the system 100 and, more specifically the control system 110, establishes a unique electronic identity associated with each product or carrier containing the product and then forms an electronic bond or electronic tether between the product and the display structure (e.g., endcap) thereby relating the product to the specific location of the retailer or merchant. In this way, the data aggregator/processor 112 is capable of identifying which products are stocked to a particular merchant/retail location using the unique electronic identity associated with the product and of identifying which products have been removed (or replaced) from a particular merchant/retail location using the unique electronic identity associated with the product.

Thus, the system 100 and, more specifically the control system 110, can establish a unique electronic identity for each product (e.g., stored value product such as stored value card 320 of FIGS. 3-5) or carrier 322 containing the product (e.g., stored value product such as stored value card 320 of FIGS. 3-5). For example, an antenna disposed relative to a display structure containing the stored value card, such as an antenna integrated with the display structure, can detect a tag coupled to and linked with the stored value card when the stored value card is located inside a defined coverage range of the antenna (e.g., 320a of FIGS. 6 and 7). That is, the antenna can detect the tag associated with the stored value card when the stored value card is placed on the display structure for retail since the display structure is located inside the defined coverage range of the antenna. The antenna (e.g., 106 of FIG. 1) can then transmit tag data 108 associated with the tag 102 to the control system 110 as described herein so that the control system 110 records the unique electronic identity associated with the stored value card coupled to and linked with the respective tag 102 (e.g., the control system 110 records stored value card identities) when the stored value card is placed on the display 540 for retail, thus creating an electronic tether or bond between the stored value card and the display structure (e.g., endcap) as part of the digital “product check in” process. In this way, the system 100 and, more specifically the control system 110, establishes a unique electronic identity associated with each stored value card or carrier containing the stored value card and then electronically tethers (or bonds) the stored value card to the display structure (e.g., endcap) thereby relating the stored value card to the specific location of the retailer or merchant.

As such, the data aggregator/processor 112 of the control system 110 is capable of identifying which stored value cards are stocked to a particular merchant/retail location using the unique electronic identity associated with the stored value card and of identifying which products have been removed (or replaced) from a particular merchant/retail location using the unique electronic identity associated with the product. In some examples, the relationship between the stored value card and the display structure (e.g., endcap) is communicated by the antenna, for example communicated to a cloud-based platform via a Wi-Fi connection on the antenna, and recorded in real time by the system 100, or more specifically the control system 110. Advantageously, this enables the retailer to identify which high-value stored value cards are associated with the display location connected to the antenna, and also to identify when a high-value stored value card leaves the defined coverage range of the antenna (e.g., leave the perimeter surrounding the antenna and display structure) using the location of the tag coupled to and linked with the high-value stored value card.

In some examples, the monitoring device 106 (e.g., antenna 506, 606, 706) can be disposed relative to the display structure where the product (e.g., stored value product such as stored value card 320) is displayed for sale (e.g., the product home base) and configured to perform digital “check out” of the product when a tag 102 that is coupled to and linked with the product exits (i.e., leaves) the defined coverage range of the monitoring device 106 (e.g., antenna) such as, for example, when the product associated with the respective tag 102 is removed from the display structure and transported outside the defined coverage range of the antenna (i.e., the tag is moved outside the perimeter surrounding the antenna) either for purchase or theft/fraud. In one or more examples, the antenna can be configured to perform a digital “check out” of a product, when the tag 102 that is coupled to and linked with the product is removed from (i.e., exits) the defined coverage range of the antenna so that the tag 102 associated with the product is located outside the defined coverage range. That is, the antenna “checks out” the product when the tag 102 associated with the product is no longer detected by (e.g., is no longer visible to) the antenna—for example, the tag associated with the product is not detected within (inside) the defined coverage range of the antenna (e.g., inside the perimeter surrounding the antenna), and thus is deemed to be located outside the defined coverage range of the antenna.

In some examples, the antenna can transmit tag data 108 associated with the tag 102 to the control system 110 so that the control system 110 identifies which products have been removed from the defined coverage range associated with the merchant/retail location using the unique electronic identity associated with the product. Additionally or alternatively, the antenna can transmit tag data 108 associated with the tag 102 to the control system 110 so that the control system 110 breaks the electronic bond or tether formed between the product (e.g., stored value product such as stored value card 320) and the display 540 (e.g., endcap) where the product (e.g., stored value product such as stored value card 320) is physically located and presented for sale by the retailer/merchant. That is, the antenna can transmit tag data 108 associated with the tag 102 to the control system 110 to break the electronic bond/tether formed between the product and the display structure (e.g., the product home base) by disassociating the connection or link established between a unique electronic identity associated with each product or carrier containing the product and the display structure (e.g., the product home base). In this way, the electronic bond or electronic tether formed between the product (e.g., stored value product such as stored value card 320) and the display 540 (e.g., the product home base) at “product check in” can be broken and disassociated at “product check out”.

In various examples, the antenna (e.g., 106 of FIG. 1) can be configured to transmit data associated with the tag 102 (e.g., tag data 108) that is no longer detected by the antenna (e.g., a tag located outside the defined coverage range of the antenna), to the control system 110 as part of a product “check out” process. A tag that is not detected by the antenna and is deemed to be located outside the defined coverage range can be referred to as a missing tag. Since the location of a tag is indicative of the location of a product that is coupled to and linked with the tag 102, a tag that is located outside the defined coverage range indicates the product associated with the tag 102 is located outside the defined coverage range. That is, a missing tag indicates a missing product that may be at risk of theft/fraud. In some examples, the antenna (e.g., 106 of FIG. 1) can transmit tag data 108 associated with the missing tag 102 to the control system 110 so that the control system 110 identifies which products have been removed from the defined coverage range associated with the merchant/retail location using the unique electronic identity associated with the product. In some examples, the antenna (e.g., 106 of FIG. 1) can transmit tag data 108 associated with the missing tag 102 to the control system 110 so that the control system 110 breaks the electronic bond/tether formed between the product and the display structure (e.g., the product home base) where the product is physically located and presented for sale by the retailer/merchant, by disassociating the connection or link established between a unique electronic identity associated with each product or carrier containing the product and the display structure (e.g., the product home base).

For example, the antenna can transmit tag data associated with a tag that is no longer visible/detected within the defined coverage range of the antenna (e.g., a missing tag) to the control system, where the product associated with the missing tag 102 has already been digitally “checked in” with the system 100, or more specifically the control system 110, such as when placed for retail. That is, the antenna can transmit tag data associated with a tag that is coupled to and linked with a product that exits the defined coverage range (e.g., product 320b of FIGS. 6 and 7), as represented by the tag that moves from a location inside the defined coverage range (e.g., from a location inside the perimeter) to a location outside the defined coverage range (e.g., to a location outside the perimeter). In this way, the data aggregator/processor 112 is capable of identifying which products have been removed (or replaced) from a particular merchant/retail location using the unique electronic identity associated with the product.

In various examples, the control system 110 is configured to record the unique electronic identity associated with the product coupled to and linked with the respective tag 102 after the product is placed on the display 540 for retail, provided that replenishment/re-stocking has been completed. In this way, the system 100 and, more specifically the control system 110, establishes a unique electronic identity associated with each product or carrier containing the product and then forms an electronic bond or electronic tether between the product and the display structure (e.g., endcap) thereby relating the product to the specific location of the retailer or merchant. Further, the system 100 and, more specifically the control system 110, can be configured to catalog/bookmark when (e.g., the specific time and date) the re-stocking event occurred, for example by generating a timestamp indicating when the re-stocking/replenishment was completed.

In one or more examples, the system 100, and more specifically the control system 110, can be configured to indicate which product (e.g., stored value product like a stored value card) has been removed from the display structure (e.g. home base) and transported outside the defined coverage range (e.g., outside the perimeter). In one or more examples, the control system 110 can identify which products have been removed from the defined coverage range associated with the merchant/retail location using the unique electronic identity associated with the product. Additionally or alternatively, the monitoring device 106 (e.g., antenna) can transmit tag data 108 associated with the tag 102 to the control system 110 so that the control system 110 breaks the electronic bond or tether formed between the product (e.g., stored value product such as stored value card 320) and the display 540 (e.g., display structure such as an endcap, shelf, platform, etc.) where the product (e.g., stored value product such as stored value card 320) is physically located and presented for sale by the retailer/merchant. That is, the control system 110 can break the electronic bond/tether formed between the product and the display structure (e.g., the product home base) by disassociating the connection or link established between a unique electronic identity associated with each product or carrier containing the product and the display structure (e.g., the product home base). In this way, the electronic bond or electronic tether formed between the product (e.g., stored value product such as stored value card 320) and the display 540 (e.g., the product home base) at “product check in” can be broken and disassociated via the “product check out” process so that the system 100, and more specifically the control system 110, resets the product inventory to reflect the product assortment contained on the display structure (e.g., home base) for retail. In one or more examples, the product is a stored value product such as a stored value card (e.g., 320 of FIGS. 3 and 4).

In these examples, the system 100, and more specifically the control system 110, can be configured to store in a data file a digital/electronic link formed between the unique tag identifier associated with the tag 102 and the unique card number associated with the stored value card with the card number paired with the tag identifier. The system 100, and more specifically the control system 110, can be configured to provide a data file to a retailer/merchant or to a data aggregator/processor 112 containing the unique proxy number associated with each stored value product (e.g., a stored value card) located outside the defined coverage range (e.g., located outside the perimeter) after replenishment/re-stocking is completed so that the retailer/merchant or data aggregator/processor 112 can validate whether the product inventory stocked to the particular merchant/retail location, and more specifically to the display structure serving as the home location (home base), has been updated within a defined timeframe. In some examples, the system 100 and, more specifically the control system 110, can establish a unique electronic identity for each stored value card 320 or carrier 322 containing the stored value card 320. An antenna disposed relative to a display structure containing the stored value card, such as an antenna integrated with the display structure, can detect a tag coupled to and linked with the stored value card when the stored value card is located inside a defined coverage range of the antenna. But, the antenna cannot detect the tag associated with the stored value card when the stored value card is transported outside the defined coverage range of the antenna. The antenna (e.g., 106 of FIG. 1) can then transmit tag data 108 associated with the tag 102 to the control system 110 for the control system 110 to identify the stored value card coupled to and linked with the respective tag 102 (e.g., the control system 110 records stored value card identities) when the stored value card removed from the defined coverage range of the antenna using the unique electronic identity associated with the stored value card, as part of the digital “product check out” process. The antenna (e.g., 106 of FIG. 1) can also transmit tag data 108 associated with the tag 102 to the control system 110 for the control system 110 to break the electronic bond/tether formed at “check in” between the stored value card and the display structure (e.g., the product home base) containing the stored value card, by disassociating the connection or link established between a unique electronic identity associated with each stored value card or carrier containing the stored value card and the display structure (i.e., the product home base).

In this way, the data aggregator/processor 112 of the control system 110 is capable of identifying which stored value cards have been removed (or replaced) from a particular merchant/retail location using the unique electronic identity associated with the stored value card. In this example, the tag data indicates the stored value card associated with (e.g., coupled to and linked with) the tag is located outside the defined coverage range since the tag is “missing” from the defined coverage range. Tag data indicating the stored value card associated with (e.g., coupled to and linked with) the tag is located outside the defined coverage range can signal the stored value card has been removed from (exited) the defined coverage range for reasons including, but not limited to, the purchase the stored value card or the theft of stored value card.

In some examples, the antenna can be configured to transmit a signal, for example the antenna can be configured to provide a signal to the control system 110 to disassociate a missing stored value card from its display location (e.g., product home base). In one or more examples, the antenna is configured to provide a signal to a cloud-based platform via a Wi-Fi connection on the antenna. Advantageously, this enables the retailer to identify which high-value stored value cards are associated with the that specific merchant/retail location, where the antenna is disposed relative to the display structure, and to identify when a high-value stored value card leaves the defined coverage range of the antenna (i.e., leave the perimeter surrounding the antenna and display structure) using the location of the tag coupled to and linked with the high-value stored value card.

In some implementations, the antenna (e.g., 506, 606, 706) is configured to transmit the tag data 108 to the data aggregator/processor 112 of the control system 110 as described herein. In some examples, the antenna (e.g., 506, 606, 706) is configured to provide tag data 108 associated with the tag 102 to the control system 110 via direct communication with the control system 110, such as by broadcasting the tag data to the control system 110. In other examples, the antenna (e.g., 506, 606, 706) is configured to provide tag data 108 associated with the tag 102 to the control system 110 via indirect communication with the control system 110, such as by transmitting the tag data to a computer located at the retailer which then communicates the tag data to the control system.

In some implementations, the antenna is integrated into a monitoring device configured to monitor the location of the stored value cards. For example, the monitoring device may be an integrated device, such as an integrated tag reader. In some examples, the monitoring device is an integrated RFID reader. The integrated RFID reader is a RFID tag reader with a built-in antenna that does not have to be connected to an external antenna. In other implementations, the antenna is a separate, distinct device that is disposed in operative electrical communication with a monitoring device, such as a gateway, a non-integrated tag reader, or a receiver. In some examples, the non-integrated tag reader is a RFID reader. In any event, the monitoring device, such as a RFID reader, functions to detect a change in state of the tag (called an event) and to communicate the state change of the tag to the antenna. In various examples, the monitoring device is a tag reader positioned relative to a display location where the stored value cards are displayed, for example a display containing the stored value cards, wherein the tag reader is configured to communicate with the tag when the tag is located within a defined coverage/communication range of the tag reader, referred to as the read range of the tag reader. In these examples, the tag reader is configured to (i) receive the data from the tag and (ii) transmit the data associated with the tag and indicative of the location of the product to which the tag is coupled and linked. In some examples, the monitoring device 106 is a RFID tag reader configured to “check in” a product associated with a RFID tag that enters the defined coverage range of the RFID tag reader and to “check out” a product associated with a RFID tag that exits the defined coverage range of the RFID tag reader.

The antenna has a defined coverage range, which is an inherent characteristic of the particular type of antenna, which can be modified as needed to suit a particular use. It should be appreciated, the antenna can be selected and configured based on the type of tag 102 being used, defined coverage range of the antenna, and overall use environment. In some implementations, the monitoring system 104 can comprise a RFID system comprising a RFID tag (e.g., tag 102), a RFID antenna (e.g., monitoring device 106), and a RFID tag reader electrically connected to the RFID antenna. In some implementations, the monitoring system 104 can comprise a BLE system comprising a BLE sensor or BLE Beacon tag (e.g., tag 102) and a BLE receiver or BLE gateway (e.g., monitoring device 106). In still other examples, the antenna is separate, independent device that is operatively coupled to a gateway (e.g., RFID tag reader), which is selected and configured according to the particular use, such as to communicate with a particular type of tag 102 over a particular coverage range extending radially outward some defined distance from the antenna.

In various examples, the antenna is configured to communicate the data associated with the tag 102, hereafter referred to as the tag data 108, to a control system 110 comprising a data aggregator/processor 112 and a database 114 communicatively coupled to the data aggregator/processor 112. In some examples, the antenna may transmit the tag data 108 to the control system 110 through direct communication with the control system 110 and without interception, handling, and/or processing by an intermediate device/system. In these examples, the antenna can transmit the tag data 108 via any suitable communication means including, but not limited to, wireless communication, for example, by broadcasting the tag data 108 over a cellular network. In some examples, a computer may receive the tag data 108 transmitted by the antenna. In these examples, the computer can be configured to receive the tag data 108 from the antenna, to recognize the identity of the tag 102 from the unique identifier (e.g., the tag identifier or tag ID) associated with the tag 102, and to transmit (or broadcast) the identity of the tag 102 to the control system 110. For example, the computer may communicate the identity of the tag 102 to the data aggregator/processor 112 of the control system 110 via wireless communication. In some examples, the computer is a remote computer located inside the retailer/merchant store. In some examples, a data file can be provided to a retailer/merchant or to a data aggregator/processor 112 containing the unique proxy number associated with each stored value product (e.g., a stored value card) located outside the defined coverage range (e.g., located outside the perimeter), to avoid sharing unique card numbers (e.g., account numbers) of stored value cards. Because the shared data consists of proxy numbers and not card numbers, the data does not need to be secured or encrypted. Advantageously, this example implementation does not require encoding the proxy number data because the information associated with the proxy number is not visible unless possessing the decoder ring. The retailer/merchant or the data aggregator/processor 112 can input the proxy numbers into their system to identify the specific stored value card that has been removed from the defined coverage range and activated via purchase of stored value card at a point of sale device, and which stored value card has been removed from the defined coverage range and subsequently located outside the defined coverage range for a period of time exceeding a defined time limit, without purchase at a point of sale device or reentering the defined coverage range within the defined time limit, and is thus considered to stolen and blocked from activation and redemption.

As described in more detail below, one or more implementations of the system and/or method of this disclosure include a rules-based reporting feature. The established link between the unique identifier of the tag 102 and the unique card number of the stored value card 320 can be provided to a customer, such as in a data file, to allow the customer to identify the type and value of the stored value card 320 based on data associated with the tag 102 transmitted by a monitoring device 106, such as an antenna (e.g., 506, 606, 706 of FIGS. 5-7, respectively). The system 100 for monitoring product (e.g., stored value product such as stored value card 320 of FIGS. 3 and 4) may be applied in different configurations depending on various factors including the cost, rate of theft, desire/need, etc. For example, a retailer may wish to monitor most if not all (e.g., a higher proportion of) the product (e.g., stored value cards of high value) in an area where theft is more prevalent. In the example shown in FIG. 3, each stored value card 320 is coupled to and linked with a tag 102 using the unique identifier associated with the tag 102. In this particular example, the stored value card 320 and the tag 102 are each placed in a carrier 322. In the example shown in FIG. 4, less than all of the stored value cards 320 are coupled to and liked with a tag 102 (e.g., one out of four carriers 322) using the unique identifier associated with the tag 102. In this particular example, the stored value card 320 and the tag 102 coupled thereto and linked therewith are placed in one carrier 322 out of the four carriers 322. It may be beneficial to monitor some (less than all) stored value cards 320 where the stored value card 320 is not as valuable and theft is not as prevalent. Further, this implementation strategy should be sufficient to capture bulk theft of stored value cards 320 even though a portion or subset of all stored value cards 320 are being monitored.

In various examples, the system 100 can further comprise a point of sale system 122 operatively coupled to the control system 110 and configured to provide point of sale data related to the product to the control system 110. In some examples, the point of sale system 122 is configured to provide the point of sale data related to the product to a database 114 for storing the point of sale data identifying product that has been purchased. In one or more examples, the point of sale system 122 is configured to provide the point of sale data related to the stored value cards to the database 114 for storing the point of sale data identifying stored value cards that have been activated. In some examples, the point of sale system 122 comprises a point of sale device where the product (e.g., stored value product) can be purchased by a customer. In some examples, the point of sale device is configured to provide the point of sale data to the database 114. In one or more examples, the product is a stored value product (e.g., stored value card 320 of FIGS. 3 and 4). In these examples, the point of sale system 122 can be configured to activate the stored value card that is purchased at the point of sale device (e.g., cash register of the retail location) within the defined time limit. Purchasing the stored value card at the point of sale device activates (e.g., legitimizes) the stored value card so that funds are transferred to the stored value card and become accessible on the stored value card.

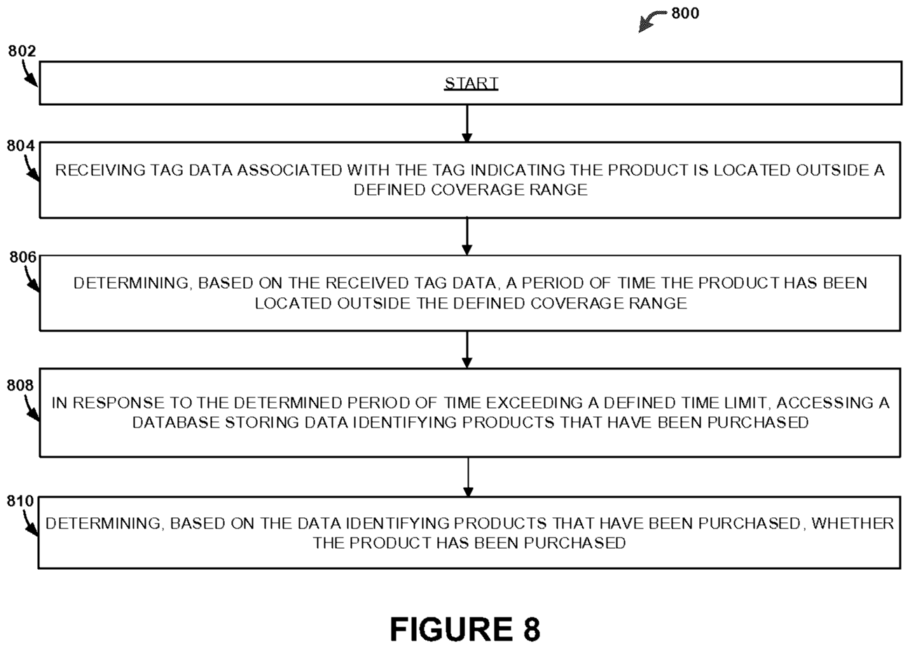

FIG. 8 is a flow diagram illustrating an example implementation of a computer-implemented method 800 for monitoring a product (e.g., a stored value product) having a tag associated therewith. In various implementations, the tag can be associated with the product by coupling the tag to the product and linking the tag with the product via a unique identifier associated with the tag. At 802, is the start of the method for monitoring a product having a tag associated therewith as described herein.

At 804, the method comprises receiving tag data associated with the tag indicating the product is located outside a defined coverage range as described herein. In some implementations, the tag data associated with the tag is provided by a monitoring device with defined coverage range that extends radially outward a fixed distance from the monitoring device and defines a perimeter around the monitoring device, wherein the perimeter is disposed at an outer periphery of the defined coverage range the fixed distance from the monitoring device. In some examples, the monitoring device comprises an antenna.

At 806, the method further comprises determining, based on the received tag data, a period of time the product has been located outside the defined coverage range as described herein. In some implementations, the determined period of time consists of a continuous period of time the product has been located outside the defined coverage range without reentering the defined coverage range or being purchased.

At 808, the method further comprises that in response to the determined period of time exceeding a defined time limit, accessing a database storing data identifying products that have been purchased as described herein. In some implementations, the data identifying products that have been purchased is point of sale data provided to the database by a point of sale device, such as a cash register at the retailer.

At 810, the method further comprises determining, based on the data identifying products that have been purchased, whether the product has been purchased as described herein. In some implementations, the method comprises determining, based on the stored point of sale data identifying products that have been purchased, whether the product has been purchased.

Optionally, the method can further comprise notifying an asset protection system that the product has not been purchased and is a subject of fraud or theft. Optionally, the method can further comprise reporting, to a data aggregator/processor, the product that has not been purchased is a subject of fraud or theft. Optionally, the method can further comprise blocking activation of the stored value card that has not been activated via purchase.

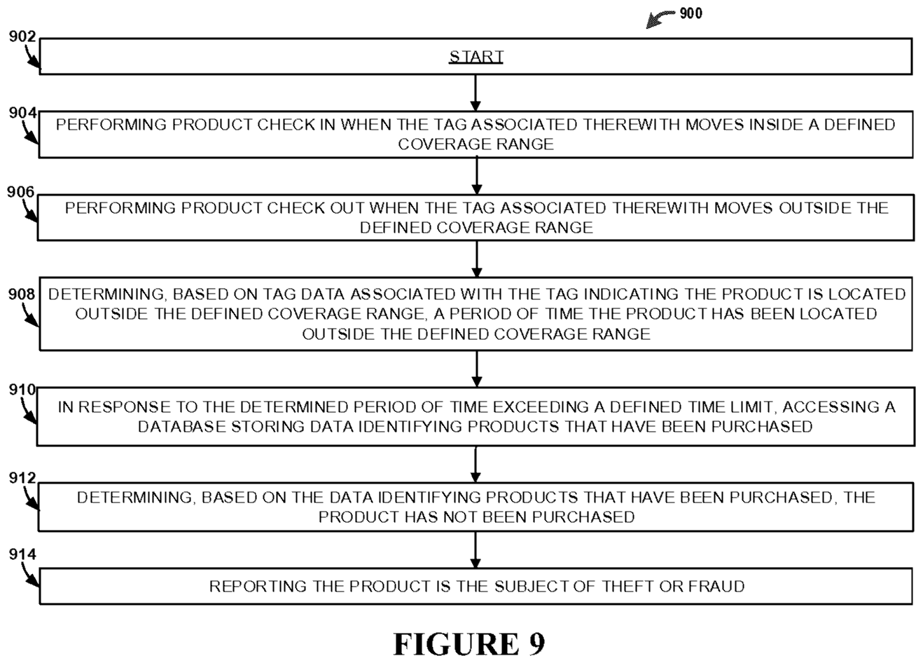

FIG. 9 is a flow diagram illustrating another example implementation of a computer-implemented method 900 for monitoring a product having a tag associated therewith. By way of illustration and not limitation, the product is a stored value product (e.g., a stored value card) having a tag associated therewith. In various implementations, the tag can be associated with the product by coupling the tag to the product and linking the tag with the product via a unique identifier associated with the tag. At 902, is the start of the method for monitoring a product having a tag associated therewith as described herein.

At 904, the method comprises performing product check in when the tag associated therewith moves inside a defined coverage range as described herein. In some implementations, the product check in is performed when the product, such as a stored value product, is placed on a display structure (e.g., endcap, shelf, platform, etc.) for retail located inside the defined coverage range as described herein. In some implementations, a monitoring device, for example an antenna, has defined coverage range that extends radially outward a fixed distance from the monitoring device and defines a perimeter around both the monitoring device and the display structure containing the product, wherein the perimeter is disposed at an outer periphery of the defined coverage range the fixed distance from the monitoring device. In some implementations, performing product check in further comprises establishing, by a control system, a unique electronic identity associated with the product; and recording, by the control system, the unique electronic identity associated with the product when the product is placed on a display structure for retail thereby forming an electronic tether between the product and the display structure that links the product to the display structure.

At 906, the method further comprises performing product check out when the tag associated therewith moves outside the defined coverage range as described herein. In some implementations, a customer or potential fraudster may remove the product from the display structure (e.g., endcap, shelf, platform, etc.), and then transport the product (e.g., a stored value product) outside the defined coverage range as described herein.

At 908, the method further comprises determining, based on tag data associated with the tag indicating the product is located outside the defined coverage range, a period of time the product has been located outside the defined coverage range as described herein. In some implementations, the determined period of time consists of a continuous period of time the product has been located outside the defined coverage range without reentering the defined coverage range or being purchased.

At 910, the method further comprises that in response to the determined period of time exceeding a defined time limit, accessing a database storing data identifying products that have been purchased as described herein. In some implementations, the data identifying products that have been purchased is point of sale data provided to the database by a point of sale device, such as a cash register at the retailer. In some implementations, the method comprises that in response to the determined period of time exceeding a defined time limit, accessing a database storing data, such as point of sale data, identifying stored value products that have been activated via purchase as described herein.

At 912, the method further comprises determining, based on the data identifying products that have been purchased, the product has not been purchased as described herein. In some implementations, the method comprises determining, based on the data (e.g., stored point of sale data) identifying stored value products that have been activated via purchase, the stored value product has not been activated via purchase.

At 914, the method further comprises reporting the product is the subject of theft or fraud as described herein. In some implementations, the method comprises reporting, to a data aggregator/processor, the product that has not been purchased is a subject of fraud or theft. In some implementations, the method can further comprise reporting (or otherwise communicating), to one or more asset protection (AP) systems, the product that has not been purchased is a subject of fraud or theft. In these implementations, the AP system can be configured to catalog/bookmark when (e.g., the specific time and date) the particular fraud or theft occurred, for example by generating a timestamp indicating when the fraud or theft was detected. The AP system can be configured to collect video and other data corresponding to the specific time period the fraud/theft was detected. That is, the AP system can be configured to collect video, images, and other data corresponding to the time period of the detected fraud/theft, for example, by acquiring data beginning a period of time (e.g., user defined) just prior to the detected theft or fraud incident to a period of time shortly after the detected theft or fraud incident (e.g., user defined). In some examples, the collected video, images, and other data corresponding to the time period of the suspected theft or fraud incident can be stored in a data storage device for later review by law enforcement personnel. In some examples, facial recognition systems could be utilized to identify customers suspected of theft or fraud and video and images acquired by internal and external cameras can acquire and store information associated with the event, such as the license plate and model of the vehicle used in the commission of the crime by the suspected thief or fraudster.

Optionally, the method can further comprise blocking activation of the stored value card that has not been activated via purchase.

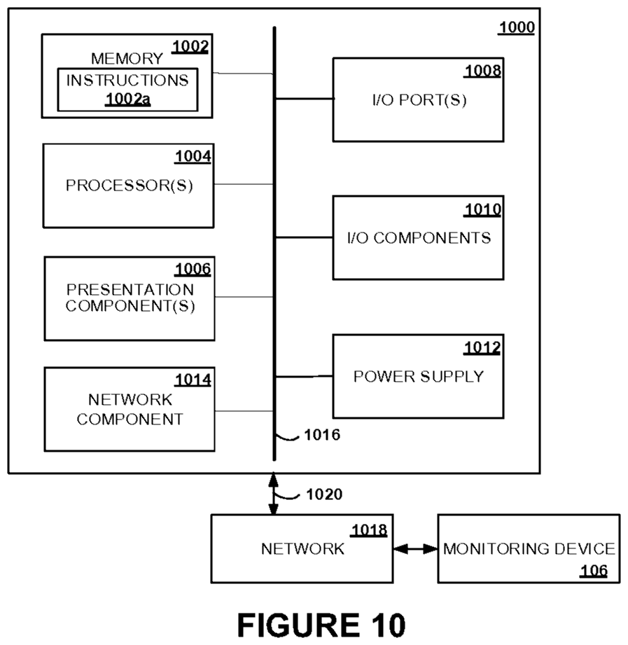

With reference now to FIG. 10, a block diagram of a computing device 1000 suitable for implementing various aspects of the disclosure as described (e.g., operations or functions for pallet tracking and monitoring). FIG. 10 and the following discussion provide a brief, general description of a computing environment in/on which one or more or the implementations of one or more of the methods and/or system set forth herein may be implemented. The operating environment of FIG. 10 is merely an example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, mobile consoles, tablets, media players, and the like), multiprocessor systems, consumer electronics, mini computers, mainframe computers, distributed computing environments that include any of the above systems or devices, and the like.

Although not required, implementations are described in the general context of “computer readable instructions” executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

In some examples, the computing device 1000 includes a memory 1002, one or more processors 1004, and one or more presentation components 1006. The disclosed examples associated with the computing device 1000 are practiced by a variety of computing devices, including personal computers, laptops, smart phones, mobile tablets, hand-held devices, consumer electronics, specialty computing devices, etc. Distinction is not made between such categories as “workstation,” “server,” “laptop,” “hand-held device,” etc., as all are contemplated within the scope of FIG. 10 and the references herein to a “computing device.” The disclosed examples are also practiced in distributed computing environments, where tasks are performed by remote-processing devices that are linked through a communications network. Further, while the computing device 1000 is depicted as a single device, in one example, multiple computing devices work together and share the depicted device resources. For instance, in one example, the memory 1002 is distributed across multiple devices, the processor(s) 1004 provided are housed on different devices, and so on.

In one example, the memory 1002 includes any of the computer-readable media discussed herein. In one example, the memory 1002 is used to store and access instructions 1002a configured to carry out the various operations disclosed herein. In some examples, the memory 1002 includes computer storage media in the form of volatile and/or nonvolatile memory, removable or non-removable memory, data disks in virtual environments, or a combination thereof. In one example, the processor(s) 1004 includes any quantity of processing units that read data from various entities, such as the memory 1002 or input/output (I/O) components 1010. Specifically, the processor(s) 1004 are programmed to execute computer-executable instructions for implementing aspects of the disclosure. In one example, the instructions 1002a are performed by the processor 1004, by multiple processors within the computing device 1000, or by a processor external to the computing device 1000. In some examples, the processor(s) 1004 are programmed to execute instructions such as those illustrated in the flow charts discussed herein and depicted in the accompanying drawings.

In other implementations, the computing device 1000 may include additional features and/or functionality. For example, the computing device 1000 may also include additional storage (e.g., removable and/or non-removable) including, but not limited to, magnetic storage, optical storage, and the like. Such additional storage is illustrated in FIG. 10 by the memory 1002. In one implementation, computer readable instructions to implement one or more implementations provided herein may be in the memory 1002 as described herein. The memory 1002 may also store other computer readable instructions to implement an operating system, an application program and the like. Computer readable instructions may be loaded in the memory 1002 for execution by the processor(s) 1004, for example.

The presentation component(s) 1006 present data indications to an operator or to another device. In one example, the presentation components 1006 include a display device, speaker, printing component, vibrating component, etc. One skilled in the art will understand and appreciate that computer data is presented in a number of ways, such as visually in a graphical user interface (GUI), audibly through speakers, wirelessly between the computing device 1000, across a wired connection, or in other ways. In one example, the presentation component(s) 1006 are not used when processes and operations are sufficiently automated that a need for human interaction is lessened or not needed. I/O ports 1008 allow the computing device 1000 to be logically coupled to other devices including the I/O components 1010, some of which is built in. Implementations of the I/O components 1010 include, for example but without limitation, a microphone, keyboard, mouse, joystick, pen, game pad, satellite dish, scanner, printer, wireless device, camera, etc.

The computing device 1000 includes a bus 1016 that directly or indirectly couples the following devices: the memory 1002, the one or more processors 1004, the one or more presentation components 1006, the input/output (I/O) ports 1008, the I/O components 1010, a power supply 1012, and a network component 1014. The computing device 1000 should not be interpreted as having any dependency or requirement related to any single component or combination of components illustrated therein. The bus 1016 represents one or more busses (such as an address bus, data bus, or a combination thereof). Although the various blocks of FIG. 10 are shown with lines for the sake of clarity, some implementations blur functionality over various different components described herein.

The components of the computing device 1000 may be connected by various interconnects. Such interconnects may include a Peripheral Component Interconnect (PCI), such as PCI Express, a Universal Serial Bus (USB), firewire (IEEE 1394), CANBUS, etherCAT, etc., an optical bus structure, and the like. In another implementation, components of the computing device 1000 may be interconnected by a network. For example, the memory 1002 may be comprised of multiple physical memory units located in different physical locations interconnected by a network.

In some examples, the computing device 1000 is communicatively coupled to a network 1018 using the network component 1014. In some examples, the network component 1014 includes a network interface card and/or computer-executable instructions (e.g., a driver) for operating the network interface card. In one example, communication between the computing device 1000 and other devices occurs using any protocol or mechanism over a wired or wireless connection 1020. In some examples, the network component 1014 is operable to communicate data over public, private, or hybrid (public and private) connections using a transfer protocol, between devices wirelessly using short range communication technologies (e.g., near-field communication (NFC), Bluetooth® branded communications, or the like), or a combination thereof.

The connection 1020 may include, but is not limited to, a modem, a Network Interface Card (NIC), an integrated network interface, a radio frequency transmitter/receiver, an infrared port, a USB connection or other interfaces for connecting the computing device 1000 to other computing devices. The connection 1020 may transmit and/or receive communication media. In some examples, the connection 1020 allows communication with the computing device 1000, configured as a transaction card monitoring system to mitigate or prevent fraud. In various examples, the computing device 1000 in combination with the computing device 1000 transmits one or more control signals to control one or more settings or operations for transaction card monitoring as described herein.

Although described in connection with the computing device 1000, examples of the disclosure are capable of implementation with numerous other general-purpose or special-purpose computing system environments, configurations, or devices. Implementations of well-known computing systems, environments, and/or configurations that are suitable for use with aspects of the disclosure include, but are not limited to, smart phones, mobile tablets, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, VR devices, holographic device, and the like. Such systems or devices accept input from the user in any way, including from input devices such as a keyboard or pointing device, via gesture input, proximity input (such as by hovering), and/or via voice input.

Implementations of the disclosure, such as controllers or monitors, are described in the general context of computer-executable instructions, such as program modules, executed by one or more computers or other devices in software, firmware, hardware, or a combination thereof. In one example, the computer-executable instructions are organized into one or more computer-executable components or modules. Generally, program modules include, but are not limited to, routines, programs, objects, components, and data structures that perform particular tasks or implement particular abstract data types. In one example, aspects of the disclosure are implemented with any number and organization of such components or modules. For example, aspects of the disclosure are not limited to the specific computer-executable instructions or the specific components or modules illustrated in the figures and described herein. Other examples of the disclosure include different computer-executable instructions or components having more or less functionality than illustrated and described herein. In implementations involving a general-purpose computer, aspects of the disclosure transform the general-purpose computer into a special-purpose computing device when configured to execute the instructions described herein.

By way of example and not limitation, computer readable media comprises computer storage media and communication media. Computer storage media include volatile and nonvolatile, removable, and non-removable memory implemented in any method or technology for storage of information such as computer readable instructions, data structures, program modules, or the like. Computer storage media are tangible and mutually exclusive to communication media. Computer storage media are implemented in hardware and exclude carrier waves and propagated signals. Computer storage media for purposes of this disclosure are not signals per se. In one example, computer storage media include hard disks, flash drives, solid-state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium used to store information for access by a computing device. In contrast, communication media typically embody computer readable instructions, data structures, program modules, or the like in a modulated data signal such as a carrier wave or other transport mechanism and include any information delivery media.

While various spatial and directional terms, including but not limited to top, bottom, lower, mid, lateral, horizontal, vertical, front and the like are used to describe the present disclosure, it is understood that such terms are merely used with respect to the orientations shown in the drawings. The orientations can be inverted, rotated, or otherwise changed, such that an upper portion is a lower portion, and vice versa, horizontal becomes vertical, and the like.

The word “exemplary” is used herein to mean serving as an example, instance or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Further, at least one of A and B and/or the like generally means A or B or both A and B. In addition, the articles “a” and “an” as used in this application and the appended claims may generally be construed to mean “one or more” unless specified otherwise or clear from context to be directed to a singular form.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Of course, those skilled in the art will recognize many modifications may be made to this configuration without departing from the scope or spirit of the claimed subject matter.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

Various operations of implementations are provided herein. In one implementation, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each implementation provided herein.

Any range or value given herein can be extended or altered without losing the effect sought, as will be apparent to the skilled person.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure.

As used in this application, the terms “component,” “module,” “system,” “interface,” and the like are generally intended to refer to a computer-related entity, either hardware, a combination of hardware and software, software, or software in execution. For example, a component may be, but is not limited to being, a process running on a processor, a processor, an object, an executable, a thread of execution, a program and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device, carrier or media. Of course, those skilled in the art will recognize many modifications may be made to this configuration without departing from the scope or spirit of the claimed subject matter.

In addition, while a particular feature of the disclosure may have been disclosed with respect to only one of several implementations, such feature may be combined with one or more other features of the other implementations as may be desired and advantageous for any given or particular application. Furthermore, to the extent that the terms “includes,” “having,” “has,” “with,” or variants thereof are used in either the detailed description or the claims, such terms are intended to be inclusive in a manner similar to the term “comprising.”

The implementations have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

What is claimed is:

1. A computer-implemented method for monitoring a product having a tag associated therewith, comprising:
receiving tag data associated with the tag indicating the product is located outside a defined coverage range;
determining, based on the received tag data, a period of time the product has been located outside the defined coverage range;
in response to the determined period of time exceeding a defined time limit, accessing a database storing data identifying products that have been purchased; and
determining, based on the data identifying products that have been purchased, whether the product has been purchased.

2. The method of claim 1, wherein the product is a stored value product, and wherein:
in response to the determined period of time exceeding the defined time limit, accessing the database storing data identifying stored value products that have been activated via purchase; and
determining, based on the data identifying stored value products that have been activated via purchase, whether the stored value product has been activated via purchase.

3. The method of claim 2, further comprising:
blocking activation of the stored value product that has not been purchased.

4. The method of claim 3, wherein the stored value product is a stored value card.

5. The method of claim 1, wherein the tag data associated with the tag is provided by a monitoring device with defined coverage range that extends radially outward a fixed distance from the monitoring device and defines a perimeter around the monitoring device, wherein the perimeter is disposed at an outer periphery of the defined coverage range the fixed distance from the monitoring device.

6. The method of claim 5, wherein the perimeter represents a communication boundary of the monitoring device for communicating with tags.

7. The method of claim 5, wherein the monitoring device comprises an antenna.

8. The method of claim 1, wherein the determined period of time consists of a continuous period of time the product has been located outside the defined coverage range without reentering the defined coverage range or being purchased.

9. The method of claim 1, wherein the data identifying products that have been purchased is point of sale data provided to the database by a point of sale device.

10. The method of claim 1, further comprising:
notifying an asset protection system that the product has not been purchased and is a subject of fraud or theft.

11. The method of claim 1, further comprising:
reporting, to a data aggregator/processor, the product that has not been purchased is a subject of fraud or theft.

12. A control system operable for monitoring a product having a tag associated therewith, the control system comprising:
a control system processor;
a non-transient memory device operatively coupled with the control system processor, the non-transient memory device storing:
tag data associated with the tag indicating the product is located outside a defined coverage range; and
a defined time limit the product is permitted to be located outside the defined coverage range; and
control logic stored in the non-transient memory device and executable by the control system processor to:
determine, based on the tag data, a period of time the product has been located outside the defined coverage range;
in response to the determined period of time exceeding a defined time limit, access a database storing data identifying products that have been purchased; and
determine, based on the data identifying products that have been purchased, whether the product has been purchased.

13. The control system of claim 12, wherein the product is a stored value card, the non-transient memory device further storing:
a link between a card number of the stored value card and a tag identifier associated with the tag.

14. The control system of claim 13, wherein the control logic stored in the non-transient memory device is executable by the control system processor to:
in response to the determined period of time exceeding the defined time limit, access the database storing data identifying stored value cards that have been activated via purchase; and
determine, based on the data identifying stored value cards that have been activated via purchase, whether the stored value card has been activated via purchase.

15. The control system of claim 14, wherein the control logic stored in the non-transient memory device is further executable by the control system processor to:
block activation of the stored value card that has not been purchased.

16. The control system of claim 12, wherein the defined coverage range extends radially outward a fixed distance from a monitoring device and defines a perimeter around the monitoring device, wherein the perimeter is disposed at an outer periphery of the defined coverage range the fixed distance from the monitoring device.

17. The control system of claim 16, wherein the monitoring device comprises an antenna.

18. The control system of claim 17, wherein the fixed distance represents a maximum distance from the antenna, wherein the maximum distance is no more than twenty feet.

19. The control system of claim 12, wherein the determined period of time consists of a continuous period of time the product has been located outside the defined coverage range without reentering the defined coverage range or being purchased.

20. The control system of claim 12, wherein the data identifying products that have been purchased is point of sale data provided to the database by a point of sale device.

21. The control system of claim 12, further comprising:
an asset protection system operatively coupled to the control system, wherein the control logic stored in the non-transient memory device is further executable by the control system processor to:
notify the asset protection system that the product that has not been purchased is a subject of fraud or theft.

22. The control system of claim 12, wherein the control logic stored in the non-transient memory device is further executable by the control system processor to:
report, to a data aggregator/processor, the product that has not been purchased is a subject of fraud or theft.

23. A computer-implemented method for monitoring a product having a tag associated therewith, comprising:
performing product check in when the tag associated therewith moves inside a defined coverage range;
performing product check out when the tag associated therewith moves outside the defined coverage range;
determining, based on tag data associated with the tag indicating the product is located outside the defined coverage range, a period of time the product has been located outside the defined coverage range;
in response to the determined period of time exceeding a defined time limit, accessing a database storing data identifying products that have been purchased;
determining, based on the data identifying products that have been purchased, whether the product has been purchased.

24. The method of claim 23, wherein performing product check in further comprises:
establishing, by a control system, a unique electronic identity associated with the product; and
recording, by the control system, the unique electronic identity associated with the product when the product is placed on a display structure for retail thereby forming an electronic tether between the product and the display structure that links the product to the display structure.

25. The method of claim 24, wherein the display structure is located inside the defined coverage range and serves as a home base for the product placed thereon for retail.

26. The method of claim 23, further comprising:
reporting, to a data aggregator/processor, the product that has not been purchased is a subject of fraud or theft.

27. The method of claim 23, wherein the product is a stored value product, and wherein:
in response to the determined period of time exceeding the defined time limit, accessing the database storing data identifying stored value products that have been activated via purchase; and
determining, based on the data identifying stored value products that have been activated via purchase, whether the stored value product has been activated via purchase.

28. The method of claim 27, further comprising:
blocking activation of the stored value product that has not been purchased.

29. The method of claim 23, wherein the tag data associated with the tag is provided by a monitoring device with defined coverage range extending radially outward a fixed distance from the monitoring device and defining a perimeter around the monitoring device, wherein the perimeter is disposed at an outer periphery of the defined coverage range the fixed distance from the monitoring device.

30. The method of claim 29, wherein the monitoring device comprises an antenna.

31. The method of claim 23, wherein the determined period of time consists of a continuous period of time the product has been located outside the defined coverage range without reentering the defined coverage range or being purchased.

32. The method of claim 23, wherein the data identifying products that have been purchased is point of sale data provided to the database by a point of sale device.

33. The method of claim 23, further comprising:
notifying an asset protection system that the product that has not been purchased is a subject of fraud or theft.
